(19) United States
(12) Patent Application Publication
(10) Pub. No.: US 2015/0339018 A1
(43) Pub. Date: Nov. 26, 2015

(54) USER TERMINAL DEVICE AND METHOD FOR PROVIDING INFORMATION THEREOF

(71) Applicant: Samsung Electronics Co., Ltd., Suwon-si (KR)

(72) Inventors: Min-jeong MOON, Seoul (KR); Mi-young LEE, Seoul (KR); Do-hyoung KIM, Suwon-si (KR); Yeon-hee JUNG, Seoul (KR); In-don JU, Seoul (KR); Hyun-jin KIM, Seoul (KR); Hae-yoon PARK, Seoul (KR)

(21) Appl. No.: 14/712,047

(22) Filed: May 14, 2015

Related U.S. Application Data
(60) Provisional application No. 62/002,390, filed on May 23, 2014.

(30) Foreign Application Priority Data
Sep. 29, 2014 (KR) 10-2014-0130469

(51) Int. Cl. G06F 3/0484; G06F 3/0488; G06F 3/01; G06F 3/0481

(52) U.S. Cl. CPC G06F 3/0484; G06F 3/0481; G06F 3/04883; G06F 3/016

(57) ABSTRACT

A user terminal device and a method for providing information thereof are provided. The method includes displaying a plurality of display items on a display screen, in response to a predetermined user command being input, displaying a User Interface (UI) for providing structure information, and in response to a specific area being selected through the structure information providing UI, providing structure information regarding at least one display item included in the selected area.

### CROSS-REFERENCE TO RELATED APPLICATION(S)

This application claims the benefit under 35 U.S.C. §119(e) of a U.S. Provisional application filed on May 23, 2014 in the U.S. Patent and Trademark Office and assigned Ser. No. 62/002,390, and under 35 U.S.C. §119(a) of a Korean patent application filed on Sep. 29, 2014 in the Korean Intellectual Property Office and assigned Serial number 10-2014-0130469, the entire disclosure of each of which is hereby incorporated by reference.

### TECHNICAL FIELD

The present disclosure relates to a user terminal device and a method of providing information thereof. More particularly, the present disclosure relates to a user terminal device which provides structure information regarding a display item included in a display screen through a structure information providing User Interface (UI).

### BACKGROUND

According to the related art, in order to execute a display item displayed on the screen, a user should recognize the location of the display item, and input a user interaction on the location in person.

However, in case of a user terminal device with a large-scale screen, it is not easy to figure out the structure of the entire screen, and it is difficult to input a user interaction with respect to a display item directly.

In addition, if a user is in a situation where it is difficult to manipulate a user terminal device due to physical disability or other circumstances (such as, driving, cooking, etc.), the user may not figure out the structure information of a display screen, and may not execute a desired display item appropriately.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user terminal device capable of providing structure information of a display screen or a display item through a structure information providing a User Interface (UI), and a method of providing information thereof.

In accordance with an aspect of the present disclosure, a method for providing information of a user terminal device is provided. The method includes displaying a plurality of display items on a display screen, displaying a UI for providing structure information in response to a predetermined user command being input, and providing structure information regarding at least one display item included in the selected area in response to a specific area being selected through the structure information providing UI.

The displaying the structure information providing UI may include displaying a structure information providing UI on an outer area of the display screen, the providing may include providing structure information regarding at least one display item included in a row corresponding to the touched point in response to a touch interaction of touching one point on an upper area or a lower area of the structure information providing UI displayed on the display screen being detected, and providing structure information regarding at least one display item included in a column corresponding to the touched point in response to a touch interaction of touching one point on a right area or a left area of the structure information providing UI displayed on the display screen being detected.

The method may include, selecting a display item group included in a row corresponding to a point where the first double tap interaction is detected, in response to a first double tap interaction of tapping one point of an upper area or a lower area of the structure information providing UI displayed on the display screen in a row being detected, and executing a display item included in a column corresponding to a point where the second double tap interaction is detected out of the display item group in response to a second double tap interaction of tapping one point of a right area or a left area of the structure information providing UI displayed on the display screen in a row being detected.

The method may include providing at least one of structure information regarding a plurality of display items included on the display screen, current time information, and incoming message information, in response to a predetermined touch interaction regarding one point of a corner area of the structure information providing UI displayed on the display screen being detected.

The method may further include, providing a predetermined vibration feedback, in response to a touch interaction of touching one point of the structure information providing UI displayed on an outer area of the display screen being detected.

Structure information regarding at least one display item corresponding to a point where the touch interaction is detected may be provided in response to a predetermined touch interaction being detected on at least one of an upper area and a right area of the structure information providing UI displayed on the display screen, and at least one display item corresponding to a point where the touch interaction is detected may be executed in response to a predetermined touch interaction being detected on at least one of a lower area and a left area of the structure information providing UI displayed on the display screen.

The displaying a structure information providing UI may include moving the structure information providing UI in a predetermined direction from one area of the display screen and displaying the structure information providing UI, and the providing may include, providing structure information regarding the at least one display item in response to at least one display item existing on an area where the structure information providing UI is located while the structure information providing UI moves.

The structure information providing UI may be in a form of bar, and the providing may include, providing structure information regarding the at least one item included in a column where the structure information providing UI is located in response to at least one display item existing in a column where the structure information providing UI in a form of bar while the structure information providing in a form of bar movers in a lower direction from an upper area, displaying a selection guide UI on one of the at least one display item in response to a column where the structure information providing UI is located being selected, executing the selected display item and in response to the at least one display item being selected through the selection guide UI.

The structure information providing UI in a form of bar may adjust at least one of a movement start location, a direction of movement, and a speed of movement according to a user interaction and a priority of a display item.

The method may further include providing one of a vibration feedback and an audio feedback from a location where the changed display item is displayed, in response to one of the plurality of display items being changed to another display item.

In accordance with another aspect of the present disclosure, a user terminal device is provided. The user terminal device includes a display configured to display a plurality of display items, an input unit configured to receive a user command, and a controller configured to control the display to display a structure information providing UI, in response to a predetermined user command being input through the input unit, and provide structure information regarding at least one display item included in the selected area in response to a specific area being selected through the structure information providing UI.

The controller may control the display to display a structure information providing UI on an outer area of the display screen, provide structure information regarding at least one display item included in a row corresponding to the touched point in response to a touch interaction of touching one point on an upper area or a lower area of the structure information providing UI displayed on the display screen being detected, and provide structure information regarding at least one display item included in a column corresponding to the touched point in response to a touch interaction of touching one point on a right area or a left area of the structure information providing UI displayed on the display screen being detected.

The controller is configured to select a display item group included in a row corresponding to a point where the first double tap interaction is detected, in response to a first double tap interaction of tapping one point of an upper area or a lower area of the structure information providing UI displayed on the display screen in a row being detected, and execute a display item included in a column corresponding to a point where the second double tap interaction is detected out of the display item group in response to a second double tap interaction of tapping one point of a right area or a left area of the structure information providing UI displayed on the display screen in a row being detected.

The controller may provide at least one of structure information regarding a plurality of display items included on the display screen, current time information, and incoming message information in response to a predetermined touch interaction regarding one point of a corner area of the structure information providing UI displayed on the display screen being detected.

The device may further include a vibration unit configured to provide a vibration feedback, and the controller configured to provide a predetermined vibration feedback, in response to a touch interaction of touching one point of the structure information providing UI displayed on an outer area of the display screen being detected.

The controller may provide structure information regarding at least one display item corresponding a point where the touch interaction is detected, in response to a predetermined touch interaction being detected on at least one of an upper area and a right area of the structure information providing UI displayed on the display screen, and execute at least one display item corresponding to a point where the touch interaction is detected in response to a predetermined touch interaction being detected on at least one of a lower area and a left area of the structure information providing UI displayed on the display screen.

The displaying a structure information providing UI may include moving the structure information providing UI in a predetermined direction from one area of the display screen and displaying the structure information providing UI, and the providing may include providing structure information regarding the at least one display item, in response to at least one display item existing on an area where the structure information providing UI is located while the structure information providing UI moves.

The structure information providing UI may be provided in a form of bar, and the controller may provide structure information regarding the at least one item included in a column where the structure information providing UI is located, in response to at least one display item existing in a column where the structure information providing UI in a form of bar while the structure information providing in a form of bar movers in a lower direction from an upper area, may display a selection guide UI on one of the at least one display item, and in response to the at least one display item being selected through the selection guide UI in response to a column where the structure information providing UI is located being selected, and may execute the selected display item in response to the at least one display item being selected through the selection guide UI. The controller may adjust at least one of a movement start location, a direction of movement, and a speed of movement according to a user interaction and a priority of a display item. The controller may provide one of a vibration feedback and an audio feedback from a location where the changed display item is displayed, in response to one of the plurality of display items being changed to another display item.

As described above, according to various embodiments of the present disclosure, even if a user is in a situation where it is difficult to manipulate a user terminal device freely, the user may check structure information of a display item displayed on a display screen easily, and manipulate the display item based on the structure information smoothly.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating configuration of a user terminal device briefly according to an embodiment of the present disclosure;

FIG. 2 is a block diagram illustrating configuration of a user terminal device in detail according to an embodiment of the present disclosure;

FIGS. 3A, 3B, 3C, 3D, 4A, 4B, 4C, 5, 6, and 7 are views provided to explain an embodiment of providing information regarding a display item through a static structure information providing User Interface (UI) according to various embodiments of the present disclosure;

FIGS. 8A, 8B, 8C, 8D, 9A, 9B, 9C, 9D, 10A, 10B, 10C, 10D, 11A, 11B, 11C, 12, 13A, and 13B are views provided to explain an embodiment of providing information regarding a display item through a dynamic structure information providing UI according to various embodiments of the present disclosure;

FIGS. 14A, 14B, 15A, 15B, 15C, 15D, 15E, 16A, 16B, 16C, 16D, 17A, 17B, 17C, 17D, 18A, and 18B are views provided to explain an embodiment of providing information regarding a display item through various feedbacks according to various embodiments of the present disclosure; and

FIG. 19 is a flowchart provided to explain an information providing method of a user terminal device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, relational terms such as first and second, and the like, may be used to distinguish one entity from another entity, without necessarily implying any actual relationship or order between such entities.

The terms used in the following description are provided to explain a specific embodiment of the present disclosure and are not intended to limit the scope of rights. The terms, “include”, “comprise”, “is configured to”, etc. of the description are used to indicate that there are features, numbers, operations, elements, parts or combination thereof, and they should not exclude the possibilities of combination or addition of one or more features, numbers, operations, elements, parts or combination thereof.

In an embodiment of the present disclosure, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

The various embodiments of the present disclosure are described below by referring to the figures.

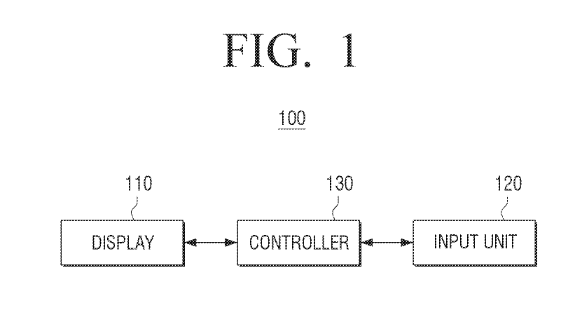

FIG. 1 is a block diagram illustrating configuration of a user terminal device 100 briefly according to an embodiment of the present disclosure.

Referring to FIG. 1, the user terminal device 100 includes a display 110, an input unit 120, and a controller 130. In this case, the user terminal device 100 may be realized as a tablet Personal Computer (PC), but this is only an example. The user terminal device 100 may be realized as various user terminal devices such as smart phone, desktop PC, notebook PC, smart Television (TV), kiosk, etc.

The display 110 displays one of image data and a User Interface (UI) received from outside under the control of the controller 130. In particular, the display 110 may display a plurality of display items (for example, widget, icon, etc.). If a predetermined user command is input while a plurality of display items are displayed, the display 110 may display a structure information providing UI for providing structure information regarding at least one of the plurality of display items.

The input unit 120 receives a user command to control the user terminal device 100. In particular, the input unit 120 may receive a user command to display a structure information providing UI and a user command to select a specific area through the structure information providing UI.

The controller 130 controls overall operations of the user terminal device 100 according to a user command input through the input unit 120. In particular, if a predetermined user command is input through the input unit 120 while a plurality of display items are displayed on the display 110, the controller 130 may control the display 110 to display a structure information providing UI.

If a specific area is selected through the structure information providing UI, the controller 130 provides structure information regarding at least one display item included in the selected area. In this case, the structure information regarding the at least one display item may include not only information regarding name, type, and size of at least one display item but also information regarding the number of display items disposed in the specific area and the disposition location of the display items.

In particular, the controller 130 may control the display 110 to display a static structure information providing UI on a specific area of the display 110 (for example, an exterior area of the display 110 which is closest to the user terminal device 100). The controller 130 may control the display 110 to display a structure information providing UI which moves in a specific direction automatically starting from the specific area (for example, the upper area of the display screen).

In an embodiment of the present disclosure, the controller 130 may control the display 110 to display a static structure information providing UI on an exterior area of the display 100. In this case, if a touch interaction of touching one point of the structure information providing UI displayed on the upper or lower area of the display 100 is detected, the controller 130 may provide structure information regarding at least one display item included in a row corresponding to the touched point. If a touch interaction of touching one point of the structure information providing UI displayed on the right or left area of the display 110 is detected, the controller 130 may provide structure information regarding at least one display item included in a column corresponding to the touched point.

In addition, if a first double tap interaction of tapping one point of the structure information providing UI displayed on the upper or lower area of the display 110 in a row is detected, the controller 130 may select a display item group included in a row corresponding to the point where the first double tap interaction is detected, and if a second double tap interaction of tapping one point of the structure information providing UI displayed on the right or left area of the display 110 in a row is detected, the controller 130 may execute a display item included in a column corresponding to the point where the second double tap interaction is detected from the display item group. In this case, the first double tap interaction and the second double tap interaction may be performed sequentially, but this is only an example. The first double tap interaction and the second double tap interaction may be performed simultaneously.

Further, if a predetermined touch interaction regarding one point of the structure information providing UI displayed on a corner area of the display screen is detected, the controller 130 may provide at least one of structure information regarding a plurality of display items included in the display screen, information regarding the current time, and information regarding incoming messages. In this case, the controller 130 may provide at least one of structure information regarding a plurality of display items, information regarding the current time, and information regarding incoming messages in an audio form.

If a touch interaction of touching one point of the structure information providing UI displayed on the exterior area of the display 110 is detected, the controller 130 may provide a vibration feedback in a predetermined pattern so that a user may recognize that the structure information providing UI is touched.

Meanwhile, the controller 130 may provide a different function according to the location of a user touch input to the structure information providing UI. For example, if a predetermined touch interaction is detected on at least one of the upper area and the right area of the structure information providing UI displayed on the display 110, the controller 130 may provide structure information regarding at least one display item corresponding to the point where the touch interaction is detected, and if a predetermined touch interaction is detected on at least one of the lower area and the left area of the structure information providing UI displayed on the display 110, the controller 130 may execute at least one display item corresponding to the point where the touch interaction is detected.

According to an embodiment of the present disclosure, the controller 130 may control the display 110 to display a dynamic structure information providing UI which may move in a specific direction starting from a specific area of the display 110 and provide structure information of a display screen.

Specifically, the controller 130 may control the display 110 to move a structure information providing UI in a predetermined direction (for example, in a lower direction) from one area (for example, an upper area) of a display screen and display the structure information providing UI. If there is at least one display item in an area where the structure information providing UI is located while the structure information providing UI moves, the controller 130 may providing structure information regarding the at least one display item. In this case, the structure information providing UI may be provided in the form of bar. For example, if there is at least one display item in a row where the structure information providing UI in the form of bar is located while the structure information providing UI in the form of bar moves in a lower direction from an upper area, the controller 130 may provide structure information regarding at least one item included in the row where the structure information providing UI is located.

If the row where the structure information providing UI is located is selected, the controller 130 may control the display 110 to display a selection guide UI on one of at least one display item. In this case, the selection guide UI may also move in a predetermined direction automatically, and the controller 130 may provide structure information regarding a display item where the selection guide UI is located. If one of at least one display item is selected through the selection guide UI, the controller 130 may execute the selected display item. Meanwhile, the structure information providing UI in the form of bar may adjust at least one of the location where the structure information providing UI starts moving, a direction of movement and a speed of movement according to a user interaction and the priority of a display item. For example, the controller 130 may set an area where a display item with high priority is displayed as a location where the structure information providing UI starts moving, and may change the direction of movement of the structure information providing UI according to a user interaction.

Through the above-described structure information providing UI, information regarding a display item displayed on a display screen is provided and thus, a user may recognize or execute the display item even if the user cannot easily recognize or control the display item displayed on a user terminal device.

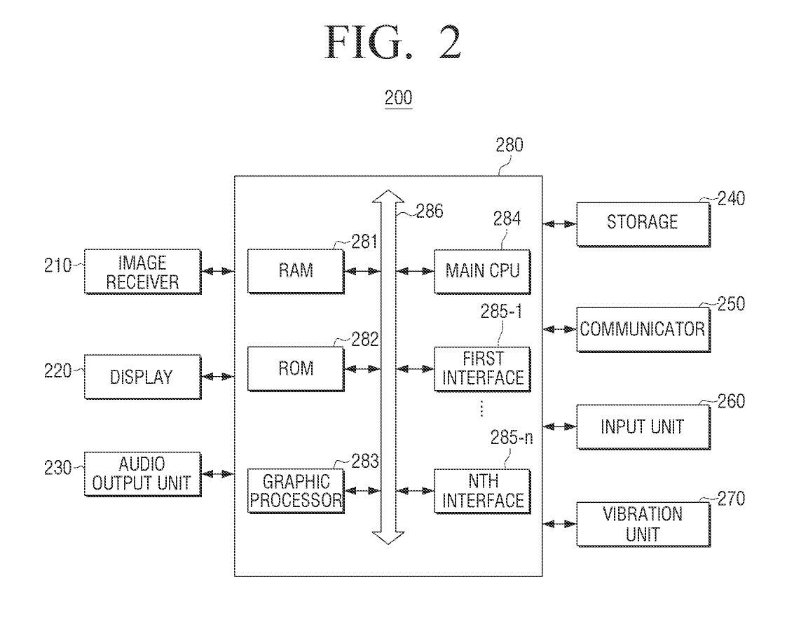

Hereinafter, various embodiments of the present disclosure will be described with reference to FIGS. 2 to 18B. Hereinafter, an embodiment of the present disclosure will be described in greater detail with reference to FIGS. 2 to 10D.

FIG. 2 is a block diagram illustrating configuration of a user terminal device 200 in detail according to an embodiment of the present disclosure.

Referring to FIG. 2, the user terminal device 200 includes an image receiver 210, a display 220, an audio output unit 230, a storage 240, a communicator 250, an input unit 260, a vibration unit 270 and a controller 280.

The image receiver 210 receives various image contents from outside. Specifically, the image receiver 210 may receive a broadcasting content from an external broadcasting station, receive an image content from an external device (for example, a Digital Versatile Disc (DVD) player, etc.), and receive a Video on Demand (VOD) content from an external server.

The display 220 displays at least one of an image content received from the image receiver 210 and various UIs processed by the graphic processor 273. In particular, the display 220 may display various types of display items. For example, the display 220 may display various display items such as a display item in the form of widget, a display item in the form of icon, and a display item with hyperlink.

In addition, the display 220 may display a structure information providing UI for providing structure information regarding a plurality of display items which are displayed on a display screen. In this case, the display 220 may display a static structure information providing UI which is displayed as it is fixed to a specific area of a display screen, and display a dynamic structure information providing UI which moves within a display screen.

The audio output unit 230 outputs not only various audio data processed by an audio processor (not shown) but also various sounds and voice messages. In particular, the audio output unit 230 may output an audio feedback including structure information regarding at least one display item included in an area selected by the structure information providing UI.

The storage 240 stores various modules to drive the user terminal device 200. For example, the storage 240 may store software including a base module, a sensing module, a communication module, a presentation module, a web browser module, and a service module. In this case, the base module refers to a basic module which processes a signal transmitted from each hardware included in the portable terminal 100, and transmits the processed signal to an upper layer module. The sensing module is a module which collects information from various sensors, and analyzes and manages the collected information. The sensing module may include a face recognition module, a voice recognition module, a motion recognition module, and a Near Field Communication (NFC) recognition module, and so on. The presentation module is a module to compose a display screen. The presentation module includes a multimedia module for reproducing and outputting multimedia contents, and a UI rendering module for UI and graphic processing. The communication module is a module to perform communication with outside. The web browser module refers to a module which accesses a web server by performing web-browsing. The service module is a module including various applications for providing various services.

As described above, the storage 240 may include various program modules, but some of the various program modules may be omitted or changed, or new modules may be added according to the type and characteristics of the user terminal device 200. For example, if the user terminal device 200 is realized as a tablet PC, the base module may further include a location determination module to determine a Global Positioning System (GPS) based location, and the sensing module may further include a sensing module to detect a user's operation.

The communicator 250 performs communication with various types of external apparatuses according to various types of communication methods. The communicator 250 may include various communication chips such as a WiFi chip, a Bluetooth chip, an NFC chip, and a wireless communication chip. Herein, the WiFi chip, the Bluetooth chip, and the NFC chip perform communication according to a WiFi method, a Bluetooth method and an NFC method, respectively. The NFC chip represents a chip which operates according to an NFC method which uses 13.56 MHz band among various Radio Frequency Identification (RF-ID) frequency bands such as 135 kHz, 13.56 MHz, 433 MHz, 860-960 MHz, 2.45 GHz, and so on. In the case of the WiFi chip or the Bluetooth chip, various connection information such as Service Set Identifier (SSID) and a session key may be transmitted/received first for communication connection and then, various information may be transmitted/received. The wireless communication chip represents a chip which performs communication according to various communication standards such as Institute of Electrical and Electronics Engineers (IEEE), Zigbee, 3^{rd} Generation (3G), 3^{rd} Generation Partnership Project (3GPP), Long Term Evolution (LTE) and so on.

The input unit 260 receives various user manipulations to control the user terminal device 200. In particular, the input unit 260 may receive a user command to display a structure information providing UI, a user command to receive structure information regarding a display item, and a user command to execute a display item.

Meanwhile, the input unit 260 may include various input devices such as a touch screen, a voice input unit, a motion input unit, a pointing device, a button, etc.

A vibration unit 270 provides a vibration feedback under the control of the controller 280. In particular, the vibration unit 270 may provide various types of vibration feedbacks according to a user interaction. For example, if a user detects a touch interaction of touching a static structure information providing UI, the vibration unit 280 may provide a vibration pattern in a predetermined pattern.

The controller 280 controls overall operations of the user terminal device 200 using various programs stored in the storage 240.

As illustrated in FIG. 2, the controller 280 includes a Random Access Memory (RAM) 281, a Read-Only Memory (ROM) 282, a graphic processor 283, a main Central Processing Unit (CPU) 284, a first to an nth interface 285-1˜285-n, and a bus 286. In this case, the RAM 281, the ROM 282, the graphic processor 283, the main CPU 284, the first to the nth interface 285-1˜285-n, etc. may be interconnected through the bus 286.

The ROM 282 stores a set of commands for system booting. If a turn-on command is input and thus, power is supplied, the main CPU 284 copies the Operating System (O/S) stored in the storage 240 in the RAM 281 according to a command stored in the ROM 282, and boots a system by executing the O/S. When the booting is completed, the main CPU 284 copies various application programs stored in the storage 240 in the RAM 281, and executes the application programs copied in the RAM 281 to perform various operations.

The graphic processor 283 generates a screen including various objects such as a pointer, an icon, an image, a text, etc. using a computing unit (not shown) and a rendering unit (not shown). The computing unit computes property values such as coordinates, shape, size, and color of each object to be displayed according to the layout of the screen. The rendering unit generates a screen with various layouts including objects based on the property values computed by the computing unit. The screen generated by the rendering unit is displayed in a display area of the display 220.

The main CPU 284 accesses the storage 240, and performs booting using the O/S stored in the storage 240. The main CPU 284 performs various operations using various programs, contents, data, etc. stored in the storage 240.

The first to the nth interface 285-1˜285-n are connected to the above-described various elements. One of the above interface may be a network interface which is connected to an external apparatus via network.

In particular, if a predetermined user command is in put through the input unit 270 while a plurality of display items are displayed on the display 220, the controller 280 may control the display 220 to display a structure information providing UI. If a specific area is selected through the structure information providing UI, the controller 280 may provide structure information regarding at least one display item included in the selected area. In this case, the structure information regarding at least one display item may include not only information regarding the name, type, and size of at least one display item but also information regarding the number of display items in the specific area, the disposition location, etc. The controller 280 may provide structure information regarding at least one display item in an audio form through the audio output unit 230, in a visual form through the display 220, or in a tactile form through the vibration unit 270.

In particular, the controller 280 may control the display 220 to display a static structure information providing UI in a specific area of the display 220 (for example, an outer area of the display 220, which is close to a bezel of the user terminal device 100), and control the display 220 to display a dynamic structure information providing UI which moves in a specific direction automatically starting from a specific area of the display 220 (for example, an upper area of a display screen).

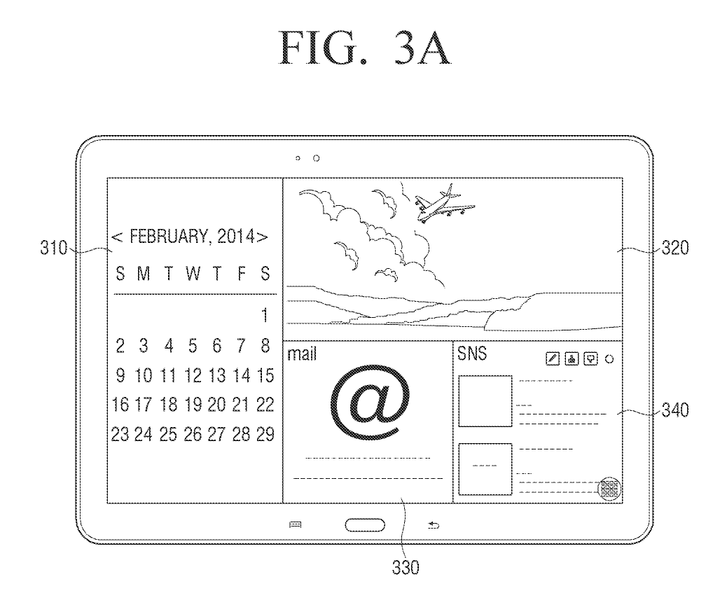

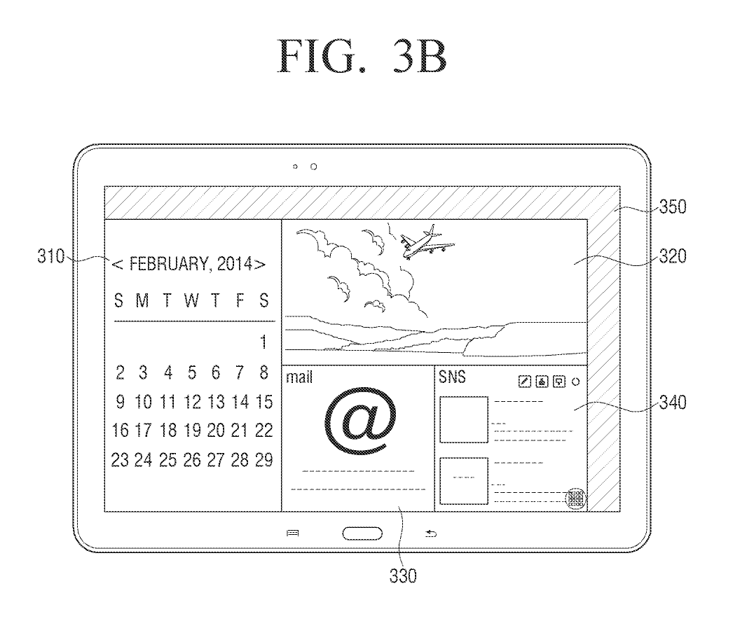

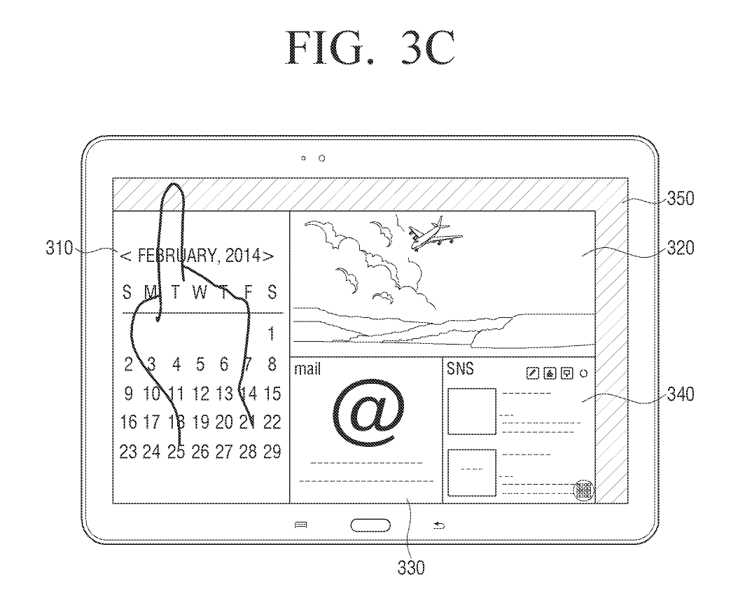

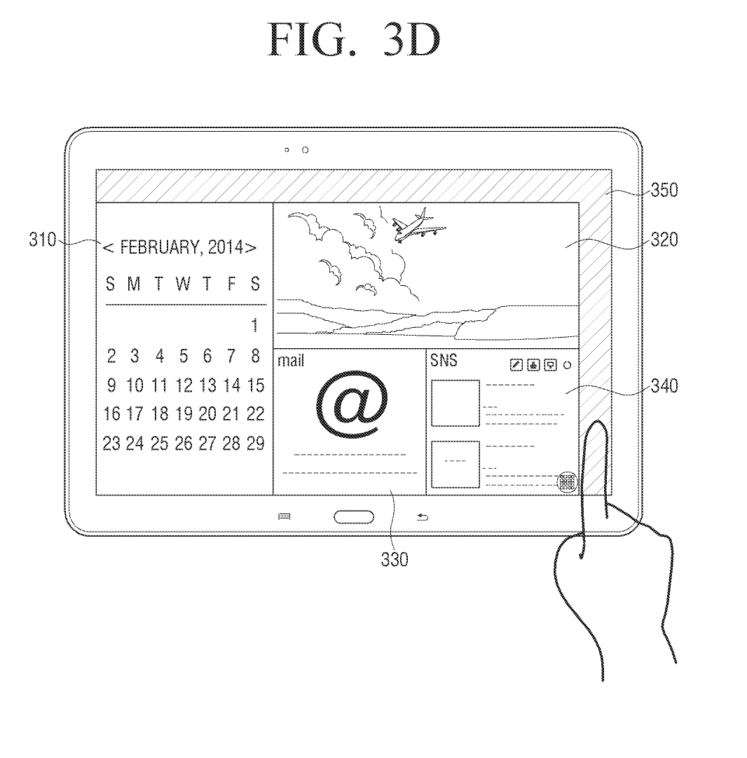

Hereinafter, an embodiment of the present disclosure providing information regarding a display item through a static structure information providing UI will be described with reference to FIGS. 3A to 7.

FIGS. 3A, 3B, 3C, 3D, 4A, 4B, 4C, 5, 6, and 7 are views provided to explain an embodiment of providing information regarding a display item through a static structure information providing UI according to various embodiments of the present disclosure.

First of all, the controller 280 may control the display 220 to display four widgets 310, 320, 330, 340 on a display screen as illustrated in FIG. 3A. In this case, the first widget 310 is a calendar widget, the second widget 320 is a video play widget, the third widget 330 is a mail widget, and the fourth widget 340 is a Social Networking Site (SNS) widget.

If a predetermined user command to enter into a structure information providing mode (for example, pressing a corner of the display screen for a predetermined time) is input while the four widgets 310, 320, 330, 340 are displayed, the controller 280 may provide a structure information providing UI 350 in the form of “ [symbol] ” in an upper area and a right area out of outer areas close to a bezel of the user terminal device 200 as illustrated in FIG. 3B.

In this case, if a touch interaction of touching one point of the upper area of the structure information providing UI 350 displayed on the display screen is detected, the controller 280 may provide structure information regarding at least one display item included in a row corresponding to the touched point.

Specifically, referring to FIG. 3C, if a touch interaction of touching a first point in the upper are of the structure information providing UI 350 is detected, the controller 280 may provide information regarding the first widget 310 included in a row corresponding to the first point. For example, the controller 280 may control the audio output unit 230 to output an audio of “calendar widget” which is the name of the first widget 310.

In addition, if a touch interaction of touching one point in the right area of the structure information providing UI 350 displayed on the display screen is detected, the controller 280 may provide structure information regarding at least one display item included in a column corresponding to the touched point.

Specifically, referring to FIG. 3D, if a touch interaction of touching a second point in the right area of the structure information providing UI 350 is detected, the controller 280 may provide information regarding the first widget 310, the third widget 330, and the fourth widget 340 included in a column corresponding to the second point. For example, the controller 280 may control the audio output unit 230 to sequentially output an audio of “calendar widget”, “mail widget”, and “SNS widget”, which are the names of the first widget 310, the third widget 330, and the fourth widget 340, respectively.

Meanwhile, in the above-described embodiment of the present disclosure, structure information regarding a display item included in a column or row corresponding to a touch point where a touch interaction is detected is provided, but this is only an example. In another embodiment of the present disclosure, structure information regarding a display item included in a column or row corresponding to a point where another interaction (for example, a drag interaction) is detected may be provided. For example, if a drag interaction is input in the upper area of the structure information providing UI 350, the controller 280 may provide structure information regarding at least one display item included in a row corresponding to the point where the drag interaction is detected.

In addition, if a predetermined touch interaction regarding one point of a corner area in the structure information providing UI of the display screen is detected, the controller 280 may provide at least one of structure information, current time information, and incoming message information regarding a plurality of display items included in the display screen. For example, if the first touch interaction is detected with respect to a corner area of the structure information providing UI 350 of the display screen, the controller 280 may control the audio output unit 230 to output an audio message of “the number of widgets currently displayed on the display screen is four”, which is the information regarding the number of display items included in the display screen. In addition, if the second touch interaction is detected with respect to a corner area of the structure information providing UI 350 of the display screen, the controller 280 may control the audio output unit 230 to output an audio message of “the time is 2:45 p.m.”, which is the information regarding the current time. If the third touch interaction is detected with respect to a corner area of the structure information providing UI 350 of the display screen, the controller 280 may control the audio output unit 230 to output an audio message of “currently, there are three messages”, which is the information regarding the number of messages which have been currently received but have not been read. In this case, the first touch interaction to the third touch interaction may be different from one another, but this is only an example. The first touch interaction to the third touch interaction may be the same interaction. If the first touch interaction to the third touch interaction are the same interaction, the controller 280 may provide the structure information of the display screen, the current time information, and incoming message information sequentially.

Meanwhile, in the above embodiment of the present disclosure, one of the structure information of the display screen, the current time information, and incoming message information is provided when a predetermined touch interaction regarding one point in a corner area of the structure information providing UI is detected, but this is only an example. When a predetermined touch interaction regarding one point in a corner area of the structure information providing UI is detected, other information (for example, weather information, absent call information, incoming SNS message information, etc.) may be provided.

In addition, at least one reference point for a haptic vibration in a different pattern may be designated in at least one point of the display screen. If a touch interaction is detected on one of at least one reference point, the controller 280 may control the vibration unit 270 to generate a haptic vibration corresponding to the reference point where the touch interaction is detected. For example, if a reference point is at the center of the display screen and a touch interaction of touching the reference point is detected, the controller 280 may control the vibration unit 270 to generate a first haptic vibration corresponding to the reference point at the center of the display screen.

In addition, if a predetermined special interaction (for example, the interaction of tapping the display screen three times in a row using more than four fingers) is detected, the controller 280 may control the communicator 250 such that the user terminal device 200 enters into an emergency mode and transmits a text message including information regarding the current location and emergency contact information (for example, 119) to a registered contact point.

In addition, the controller 280 may execute at least one display item through the structure information providing UI.

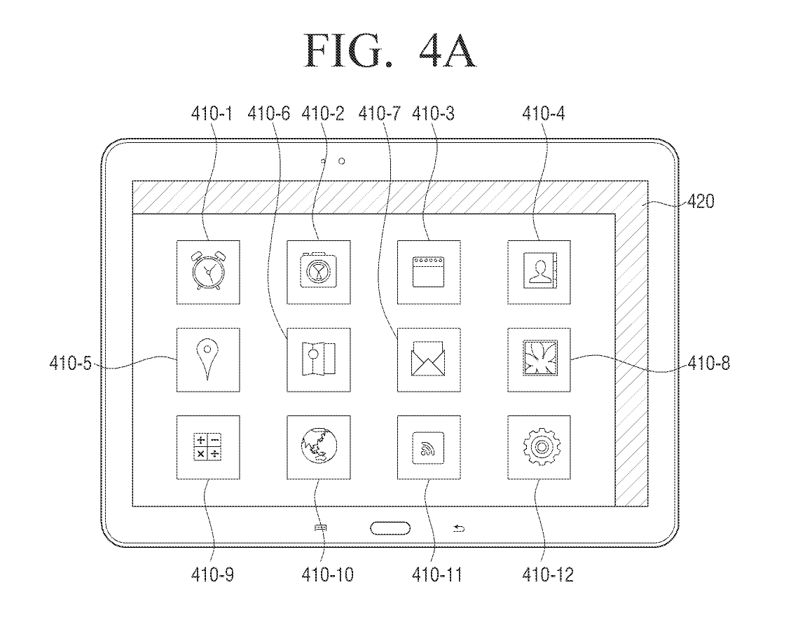

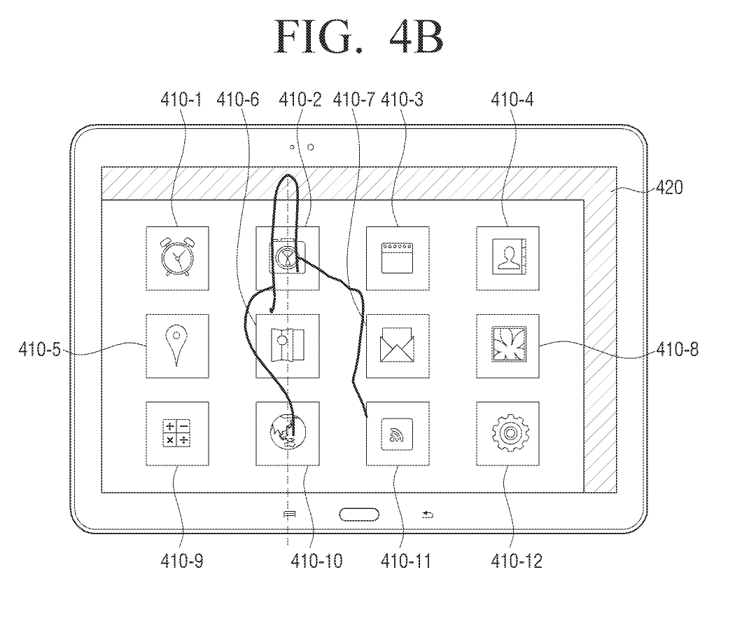

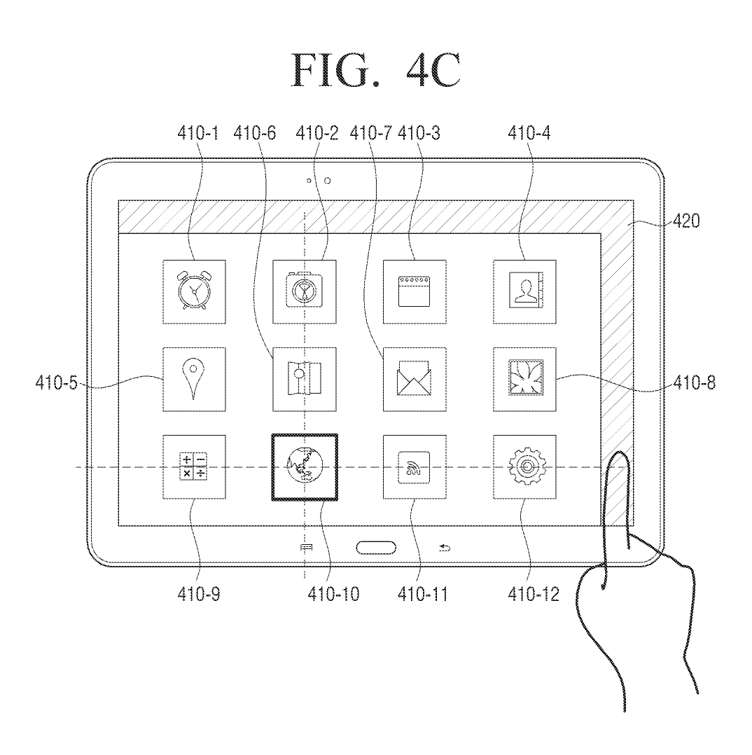

Specifically, if a user command to enter into a structure information providing mode is input while twelve icons 410-1 to 410-12 are displayed, the controller 280 may provide a structure information providing UI 420 in the form of “ [symbol] ” in the upper area and the right area out of outer areas close to a bezel of the user terminal device 200 as illustrated in FIG. 4A.

If the first double tap interaction of tapping one point in the upper area of the structure information providing UI 420 displayed on the display screen successively is detected, the controller 280 may select a display item group included in a row corresponding to the point where the first double tap interaction is detected. In other words, as illustrated in FIG. 4B, if the first double tap interaction of tapping a point corresponding to the second row successively is detected, the controller 280 may select a display item group including the second icon 410-2, the sixth icon 410-6, and the tenth icon 410-10 included in the row corresponding to the first double tap interaction. In this case, the display item group may be displayed in a dot line in order to be distinguished from other display items as illustrated in FIG. 4B.

If the second double tap interaction of tapping one point in the right area of the structure information providing UI 420 displayed on the display screen is detected, the controller 280 may execute a display item included in a column corresponding to the point where the second double tap interaction is detected out of the display item group.

In other words, referring to FIG. 4C, if the second double tap interaction of tapping the point corresponding to the third column in a row is detected, the controller 280 may execute the tenth icon 410-10 included in the third column out of a display item group corresponding to the second row. In this case, the executed tenth icon 410-10 may be displayed distinctively from other display items.

Meanwhile, in the above embodiment of the present disclosure, the first double tap interaction and the second double tap interaction are input sequentially, but this is only an example. The first double tap interaction and the second double tap interaction may be input simultaneously. For example, if the first double tap interaction is input to a point corresponding to the third row and the second double tap interaction is input to a point corresponding to the first column at the same time, the controller 280 may execute the third icon 410-3.

In addition, in the above embodiment of the present disclosure, a display item is executed through a double tap interaction, but this is only an example. A different function may be performed by adding another interaction. For example, if a double tap holding interaction of touching one point of the structure information providing UI 420 in a row and holding the point is detected, the controller 280 may control the display 220 to display a menu for controlling a selected display item (for example, deleting, editing, storing, etc.) around the selected display item.

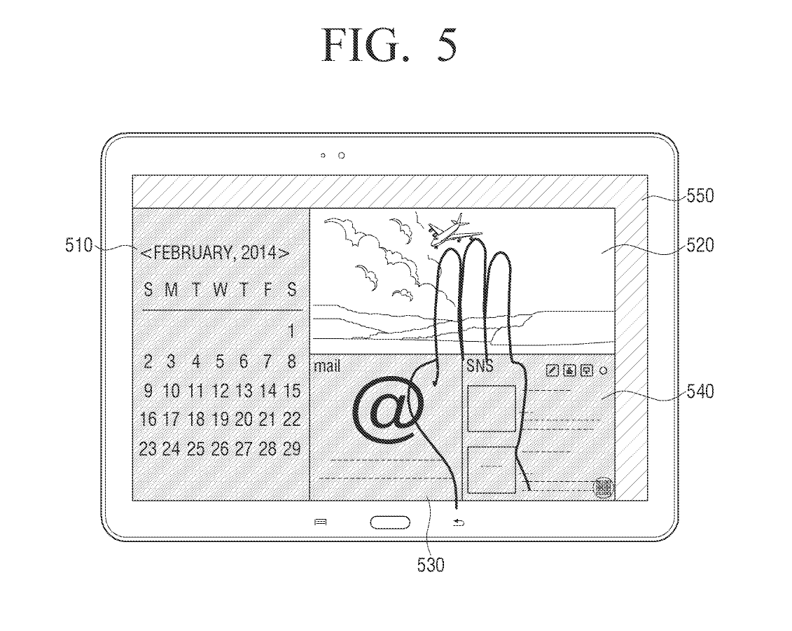

In addition, if a predetermined interaction is detected on one display item while a plurality of display items are displayed, the controller 280 may perform a lock function with respect to the remaining display items in order to control only the display item where the predetermined interaction is detected. For example, referring to FIG. 5, if a three-finger touch interaction of touching three fingers on the second widget 520 simultaneously is detected, the controller 280 may activate only the second widget 520 and perform a lock function with respect to the first widget 510, the third widget 530, and the fourth widget 540 as shown in FIG. 5 so as to blur the screen. In this case, if the three-finger touch interaction is detected again on a certain area of the display screen not including the structure information providing UI 550, the controller 280 may release the lock function.

Meanwhile, in the above embodiment of the present disclosure, a static structure information providing UI is displayed on the upper area and the right area from among outer areas of the display screen, but this is only an example.

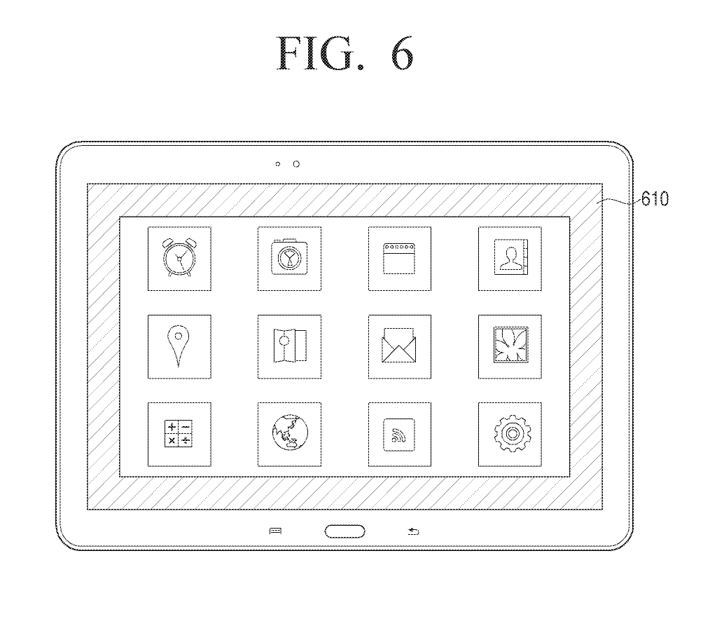

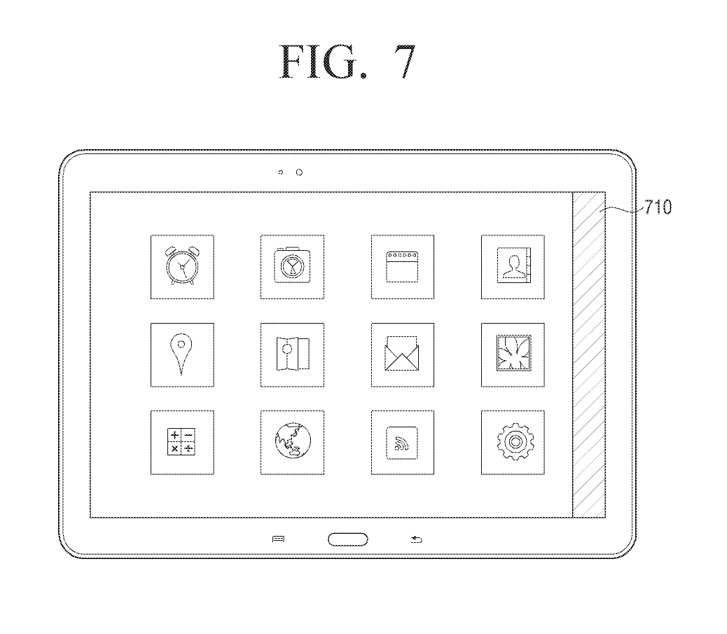

Referring to FIG. 6, the structure information providing UI 610 may be displayed on every outer area of the display screen, and referring to FIG. 7, the structure information providing UI 710 may be displayed on an outer area corresponding to one side out of the four sides of the display screen.

In particular, as illustrated in FIG. 6, if the structure information providing UI 610 is displayed on every outer area of the display screen, the controller 280 may control to perform a different function according to the area where a touch interaction is detected. For example, if a predetermined touch interaction is detected on at least one of the upper area and the right area of the structure information providing UI 610 displayed on the display screen, the controller 280 may provide structure information regarding at least one display item corresponding to the point where the touch interaction is detected, and if a predetermined touch interaction is detected on at least one of the lower area and the left area of the structure information providing UI 610 displayed on the display screen, the controller 280 may execute at least one display item corresponding to the point where the touch interaction is detected.

In addition, as illustrated in FIG. 7, if the structure information providing UI 710 is displayed only on an outer area corresponding to one side, the controller 280 may provide structure information through the structure information providing UI 710, and select or execute a display item through a separate interaction (for example, a flick interaction in the left and right directions).

Meanwhile, if a user touches a structure information providing UI in an embodiment of providing a static structure information providing UI, the controller 280 may control the vibration unit 270 to provide a haptic vibration. Specifically, if a user touches a structure information providing UI to allow a visually impaired user or a user on the wheel to recognize a location where the structure information providing UI is displayed without looking at the display screen, the controller 280 may control the vibration unit 270 to provide a haptic vibration.

Meanwhile, in the above embodiment of the present disclosure, a structure information providing UI is displayed on an outer area of the display screen, which is close to a bezel so as to provide a user with structure information of a display item, but this is only an example. The structure information of a display item may be provided to a user through a touchable bezel. In other words, if a touch interaction of touching one point of a bezel at the upper area is detected, the controller 280 may provide structure information regarding at least one display item included in a row corresponding to the touched point. In addition, if a touch interaction of touching one point of a bezel at the right area is detected, the controller 280 may provide structure information regarding at least one display item included in a column corresponding to the touched point. In this case, the controller 280 may provide a haptic feedback to the touched point of the bezel.

As described above, as a static structure information providing UI is provided on a fixed area, even in a case where a user may not recognize or execute a display item, the user may easily recognize structure information of a display screen through the structure information providing UI and execute the display item more conveniently.

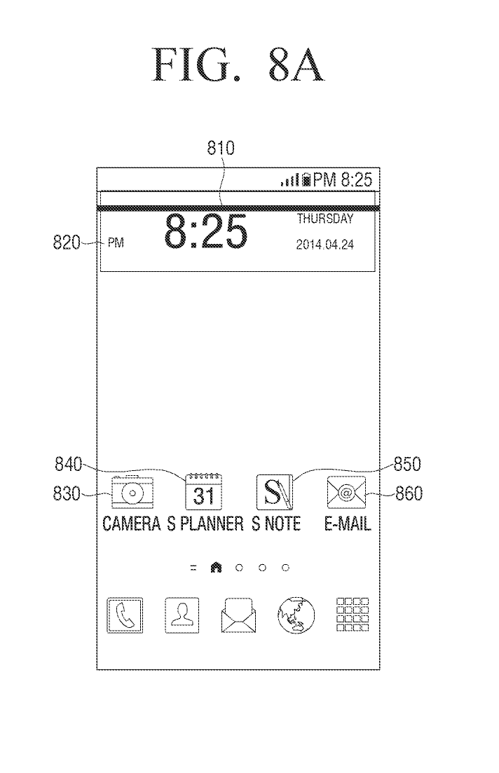

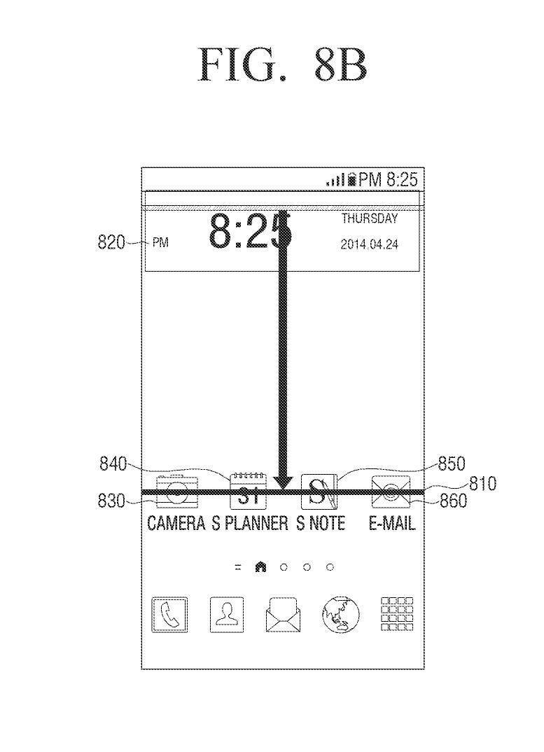

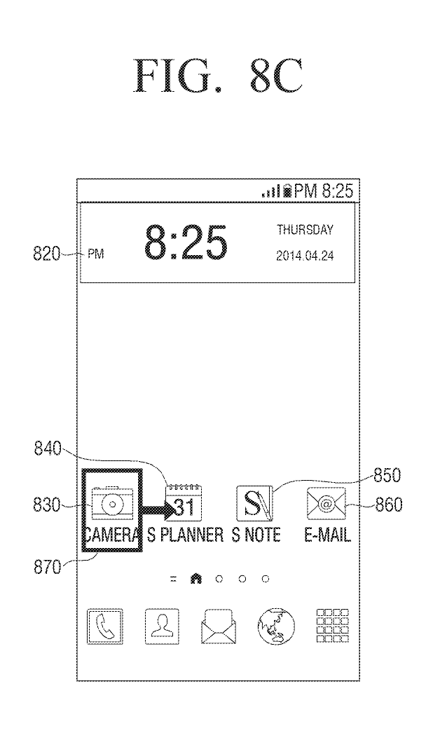

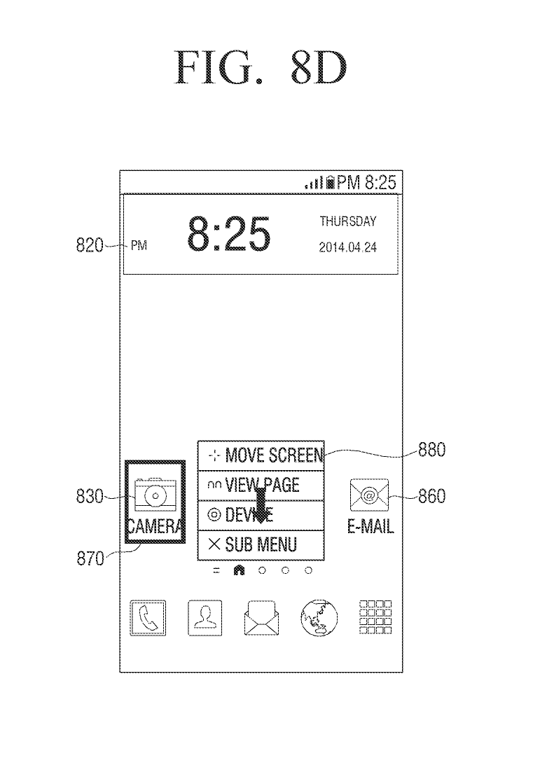

Hereinafter, an embodiment of providing information regarding a display item through a dynamic structure information providing UI will be described with reference to FIGS. 8A to 13B.

FIGS. 8A, 8B, 8C, 8D, 9A, 9B, 9C, 9D, 10A, 10B, 10C, 10D, 11A, 11B, 11C, 12, 13A, and 13B are views provided to explain an embodiment of providing information regarding a display item through a dynamic structure information providing UI according to various embodiments of the present disclosure.

If a predetermined user command to enter into a structure information providing mode is input while a plurality of display items (820 to 860) are displayed on the display screen, the controller 280 may control the display 220 to display a structure information providing UI 810 in the form of bar on the upper end of the display screen as illustrated in FIG. 8A. In this case, the structure information providing UI 810 in the form of bar may move in the lower direction automatically starting from the upper area.

In addition, referring to FIG. 8A, if the structure information providing UI 810 in the form of bar is located on the clock widget 820, the controller 280 may control the audio output unit 230 to output an audio message of “the current time is 8:25” which is the current time information.

If the structure information providing UI 810 in the form of bar moves in the lower direction and is located at a column where the first icon to the fourth icon (830 to 860) are displayed as illustrated in FIG. 8B, the controller 280 may provide information regarding the first to the fourth icons (830 to 860). Specifically, the controller 280 may provide information regarding the name and the number of the first to the fourth icons through the audio output unit 230. If a column where the structure information providing UI in the form of bar is located is selected, the controller 280 may control the display 220 to display a selection guide UI on one of at least one display item. Specifically, as illustrated in FIG. 8C, the controller 280 may control the display 220 to display a selection guide UI 870 on the first icon 830. In this case, the selection guide UI 870 may also move in a specific direction (for example, in the right direction) automatically.

If one of the at least one display item is selected through the selection guide UI, the controller 280 may execute the selected display item. Specifically, if a selection command is input while the selection guide UI 870 is displayed on the first icon 830, the controller 280 may execute a function corresponding to the first icon 830. In addition, if a menu generation command is input while the selection guide UI 870 is displayed on the first icon 830, the controller 280 may control the display 220 to display a menu 880 for controlling the first icon 830 as illustrated in FIG. 8D. Meanwhile, not only the menu 880 but also a structure information providing UI may be displayed. In this case, the structure information providing UI may be provided in the form of highlight.

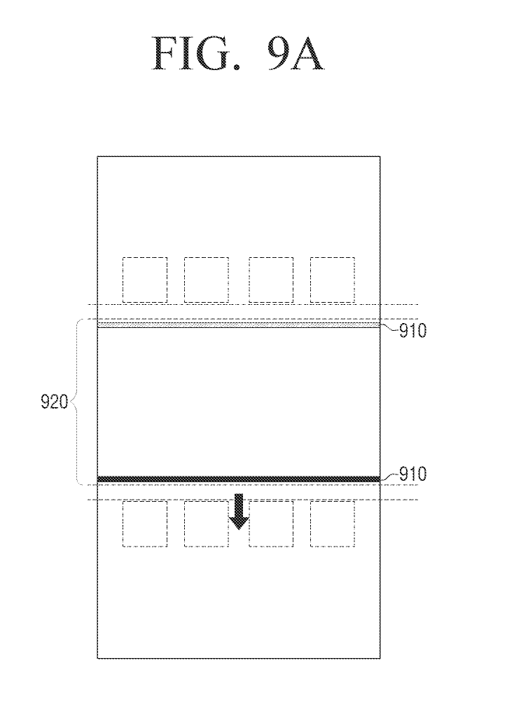

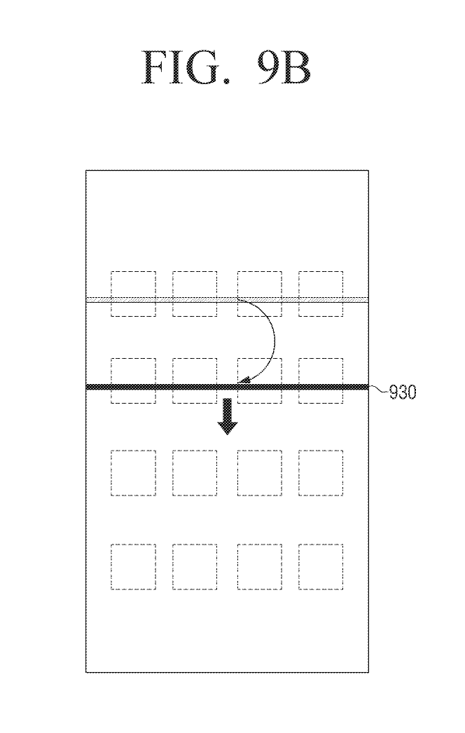

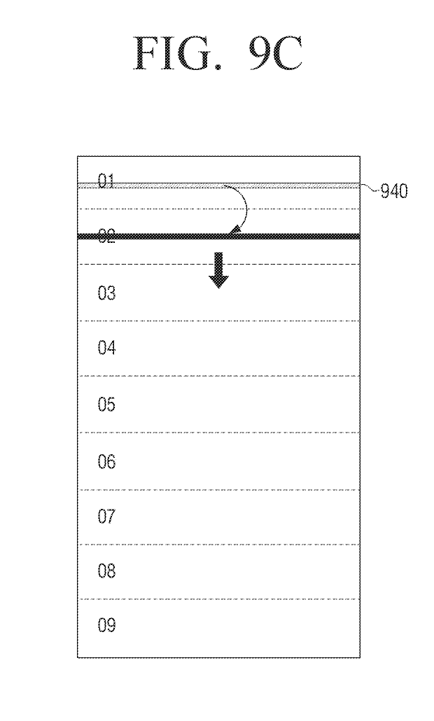

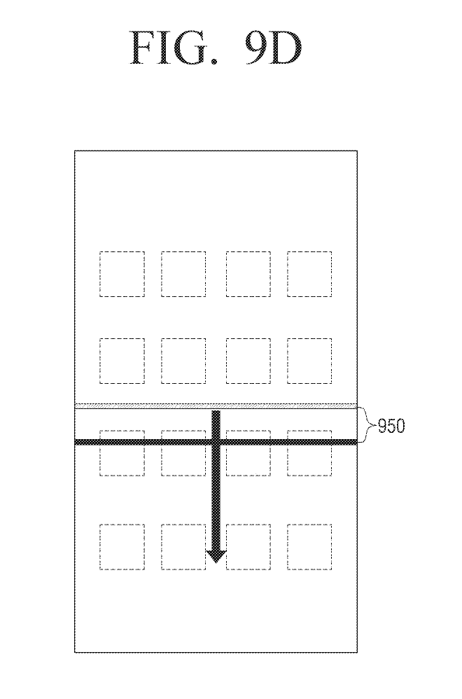

In an embodiment of the present disclosure, the controller 280 may control a structure information providing UI 910 to move from an upper end icon group directly to a lower icon group by skipping an area 920 where an icon is not displayed as illustrated in FIG. 9A in order to reduce the time required for a user to analyze structure information of the display screen. In addition, as illustrated in FIG. 9B, the controller 280 may control the structure information providing UI 930 to move by hopping every icon group instead of moving continuously. In addition, as illustrated in FIG. 9C, the controller 280 may provide a structure information providing UI 940 in the form of highlight and control the structure information providing UI 940 to move between a plurality of items included in a list. As illustrated in FIG. 9D, the controller 280 may set a center as a location where a structure information providing UI 950 in the form of bar starts moving.

The controller 280 may adjust the speed of movement or the direction of movement of a structure information providing UI or a selection guide UI according to a user interaction.

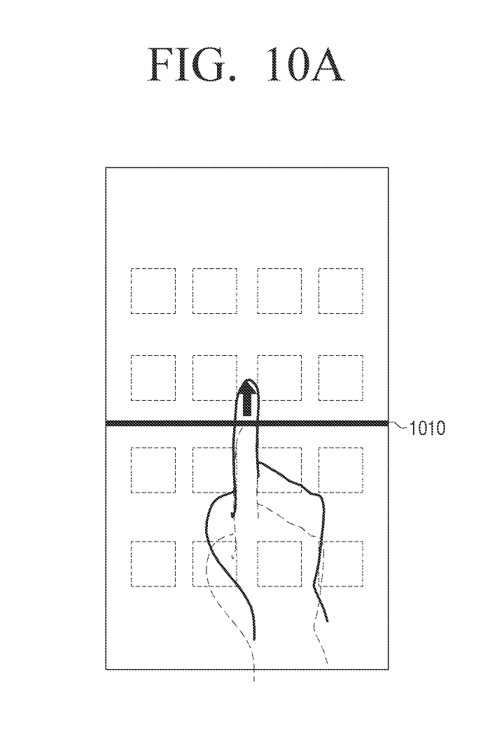

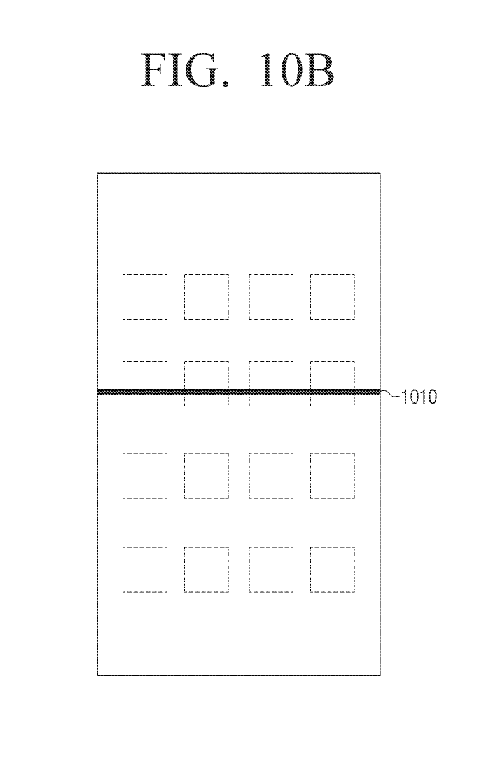

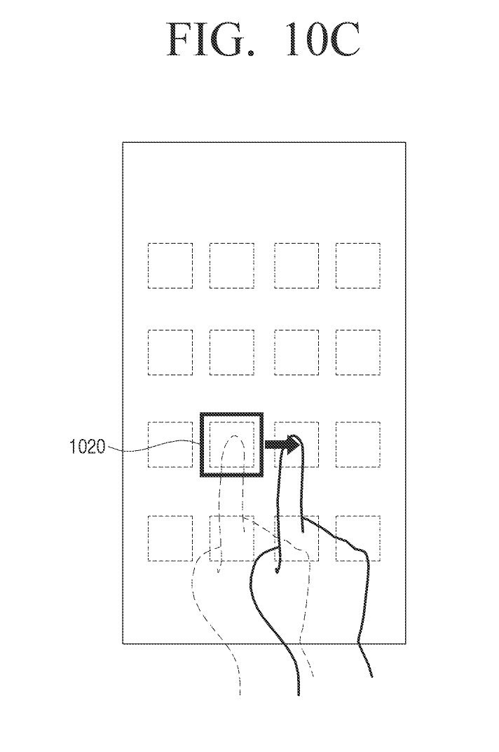

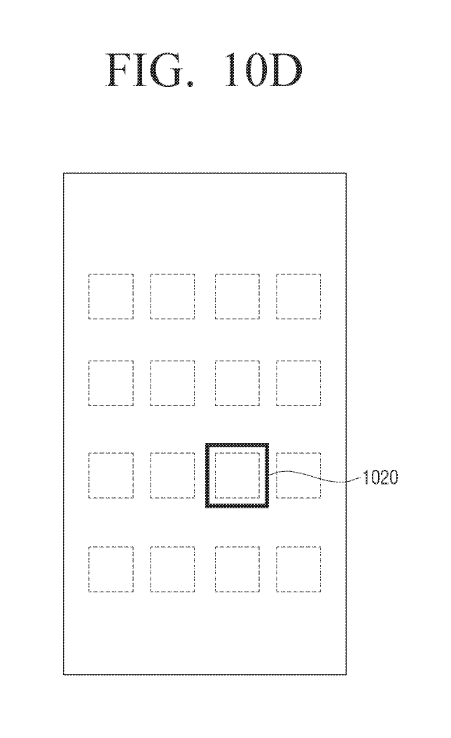

Specifically, referring to FIG. 10A, if a flick interaction in the upper direction is detected while a structure information providing UI 1010 in the form of bar is displayed at the center of the display screen, the controller 280 may control the structure information providing UI 1010 in the form of bar to move in the upper direction as illustrated in FIG. 10B.

In addition, referring to FIG. 10C, if a flick interaction in the right direction is detected while a selection guide UI 1020 is displayed on a certain icon, the controller 280 may control the selection guide UI 1020 to move in the right direction as illustrated in FIG. 10D.

The controller 280 may adjust the speed of the structure information providing UI 1010 or the selection guide UI 1020 based on the distance where a flick interaction is detected or the intensity of a flick interaction.

In addition, the controller 280 may select a specific area through a structure information providing UI in various forms.

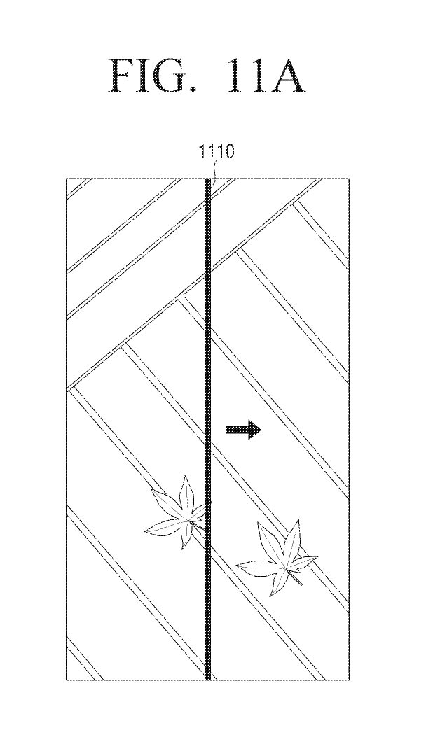

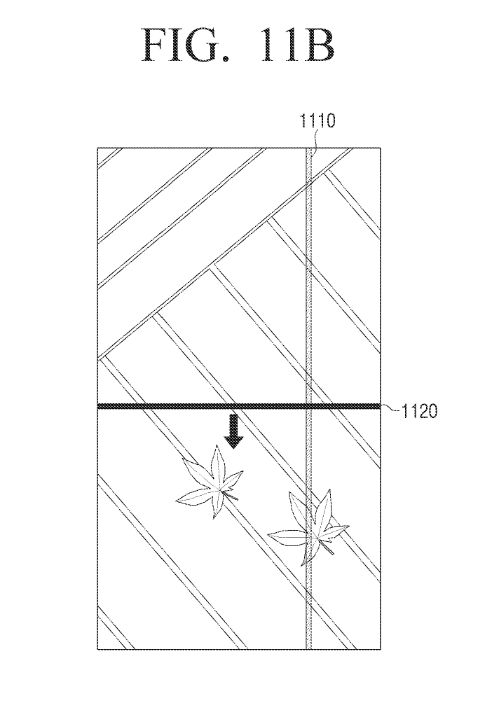

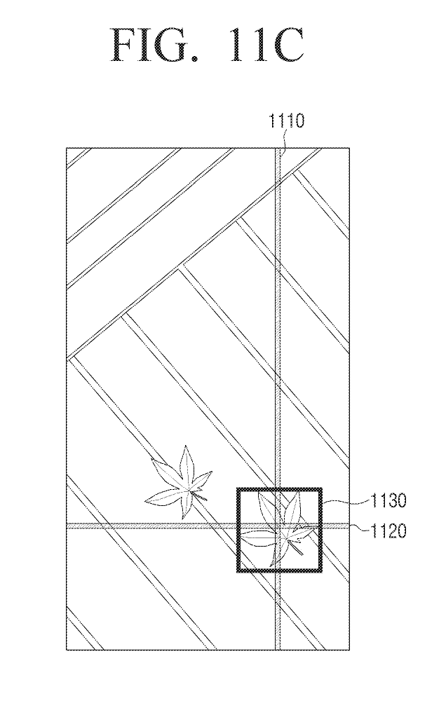

Specifically, referring to FIG. 11A, the controller 280 may allow a user to select a row through a structure information providing UI 1110 in the form of vertical bar. In this case, the controller 280 may set an important portion (for example, a location close to an object) through image analysis as the location where the structure information providing UI 1110 starts moving. After determining the location of a row which a user wishes to select through the structure information providing UI 1110 in the form of bar, the controller 280 may select the row that the user wishes to select through a structure information providing UI 1120 in the form of horizontal bar as illustrated in FIG. 11B. When a specific point is selected through the structure information providing UI 1110 in the form of vertical bar and the structure information providing UI in the form of horizontal bar, the controller 280 may control the display 220 to display a selection area 1130 including an object displayed in the selected point distinctively from other areas as illustrated in FIG. 11C.

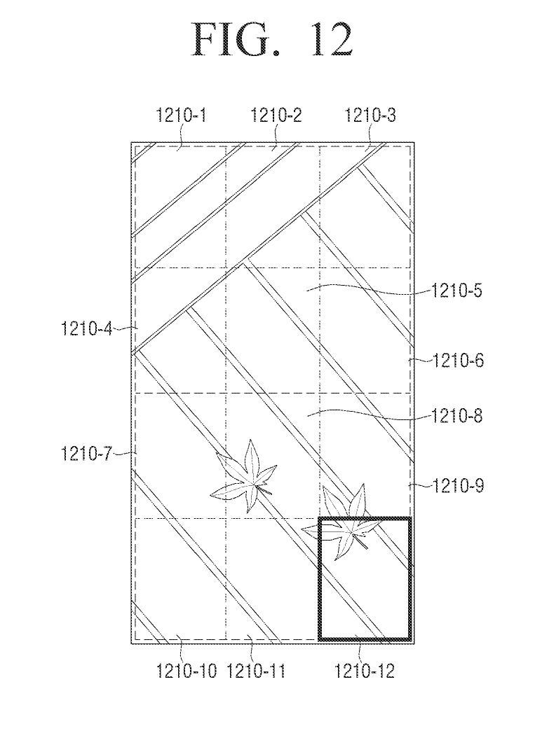

The controller 280 may select a specific area through a screen which is divided into a plurality of areas. Specifically, referring to FIG. 12, the controller 280 may control the display 220 to display a structure information providing UI in the form of grid including twelve areas (1210-1 to 1210-12). In this case, the controller 280 may control the display 220 to select one of the twelve areas and display the selected area distinctively from other areas.

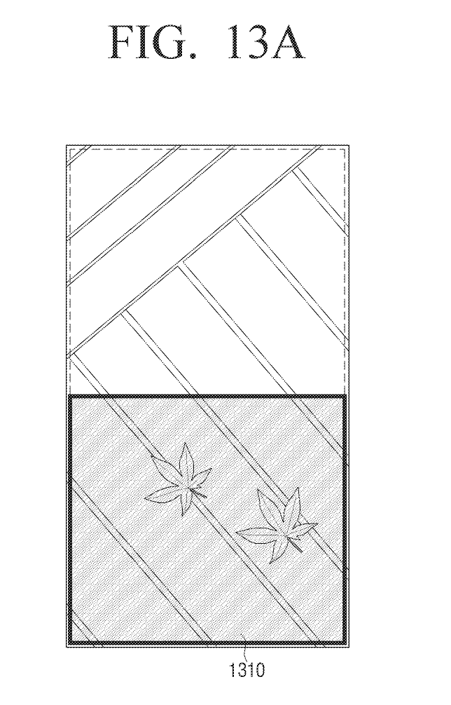

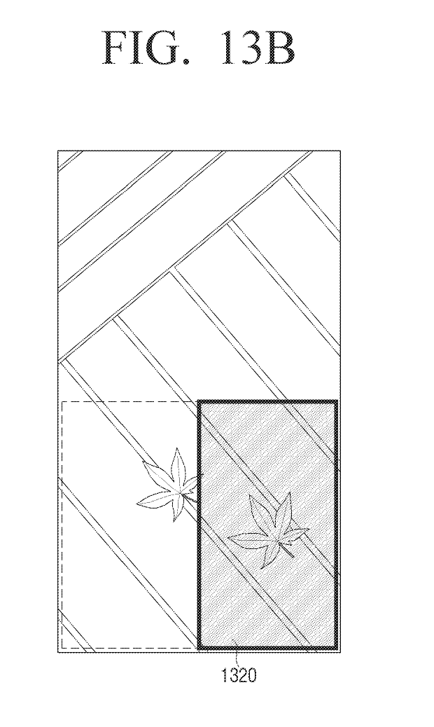

In addition, the controller 280 may select a desired point by reducing a selection area from a large area to a small area. Specifically, referring to FIG. 13A, the controller 280 may preferentially select a lower area 1310 and then, as illustrated in FIG. 13B, may select the right area in the lower area 1320. Subsequently, the controller 280 may control the display 220 to display the selected area distinctively from other areas.

As described above, a user may not only recognize structure information of a display screen more smoothly but also execute a display item through a structure information providing UI which moves dynamically even without watching or touching the display screen.

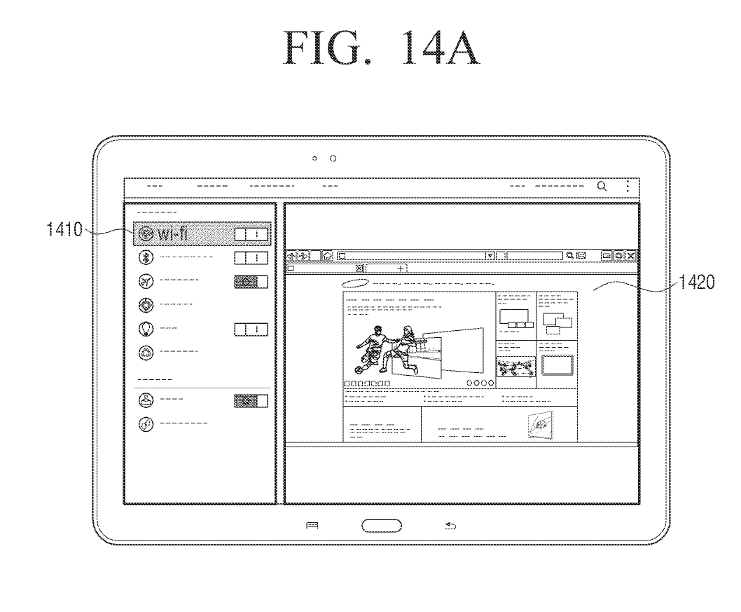

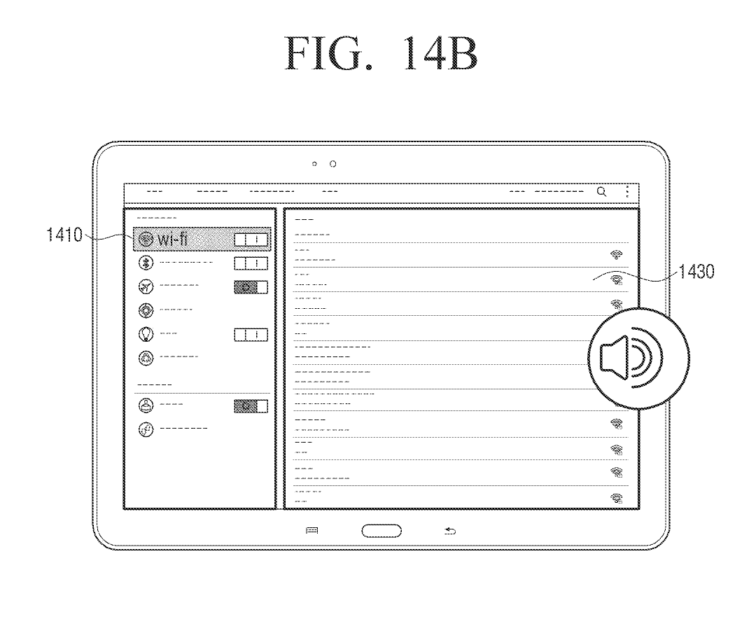

Hereinafter, an embodiment of providing information regarding a display item through various feedbacks will be described with reference to FIGS. 14A to 18B.

FIGS. 14A, 14B, 15A, 15B, 15C, 15D, 15E, 16A, 16B, 16C, 16D, 17A, 17B, 17C, 17D, 18A, and 18B are views provided to explain an embodiment of providing information regarding a display item through various feedbacks according to various embodiments of the present disclosure.

According to an embodiment of the present disclosure, if one of a plurality of display items is changed to another display item, the controller 280 may provide one of a vibration feedback and an audio feedback from a location where the changed display item is displayed.

Specifically, referring to FIG. 14A, if a WiFi icon 1410 is selected from among a plurality of icons included in a first area while an image content 1420 is displayed on a second area, the controller 280 may change the image content 1420 displayed on the second area to a WiFi setting screen 1430 as illustrated in FIG. 14B. In this case, the controller 280 may control the audio output unit 230 to output an audio message of “WiFi Screen” from a speaker close to the second area. According to an embodiment of the present disclosure, the controller 180 may control the vibration unit 270 to generate a haptic vibration in an area close to the second area. According to an embodiment of the present disclosure, the controller 280 may control the display 220 to provide a fade in/fade out effect to the second area of which screen has been changed.

In addition, the controller 280 may control the vibration unit 270 to provide number information through a haptic vibration. Specifically, the controller 280 may represent the digit of a number with a vibration pattern of a haptic vibration and the amount of a number with the number of haptic vibration.

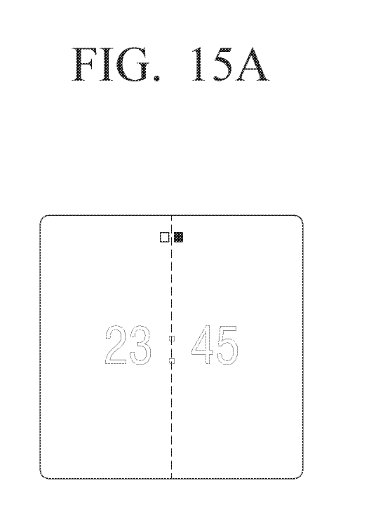

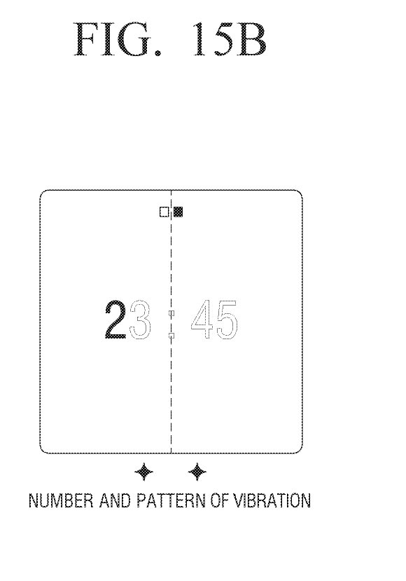

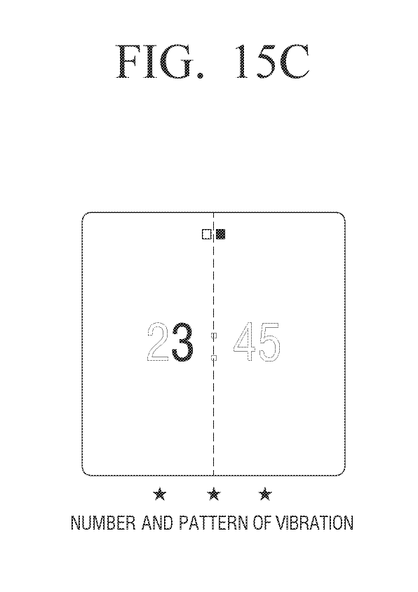

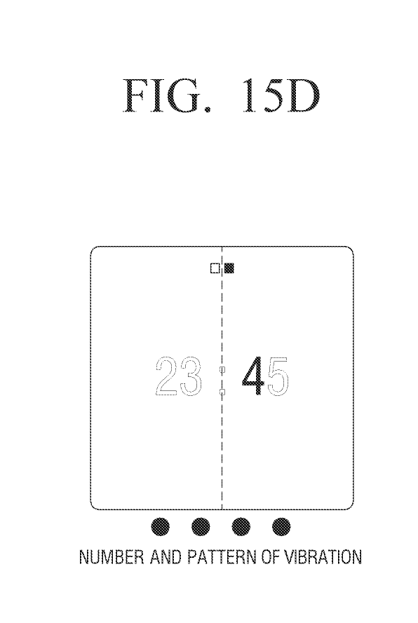

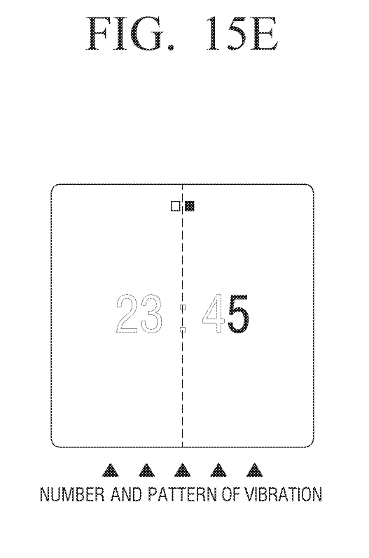

Specifically, referring to FIG. 15A, in order to represent 23:45 with a haptic vibration, the controller 280 may control the vibration unit 270 to generate a vibration in a first vibration pattern twice for the second digit of the time of hour as illustrated in FIG. 15B, generate a vibration in a second vibration pattern three times for the first digit of the time of hour as illustrated in FIG. 15C, generate a vibration in a third pattern four times for the second digit of the time of minute as illustrated in FIG. 15D, and generate a vibration in a fourth pattern five times for the first digit of the time of minute as illustrated in FIG. 15E.

As described above, by providing number information using vibration information, when it is impossible to check information visually/aurally, number information such as time, residual battery, unread messages, and the number of unanswered calls may be checked through a vibration feedback.

According to an embodiment of the present disclosure, the controller 280 may set areas for putting a background color in an icon and a text in order to enhance visibility of the icon and the text.

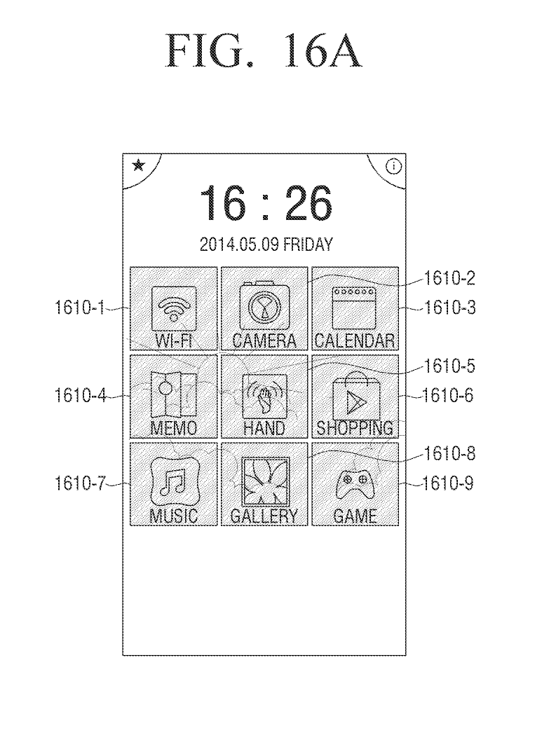

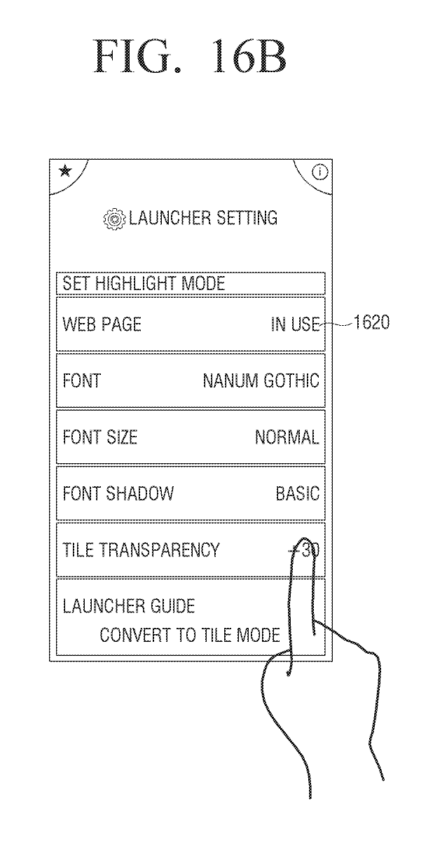

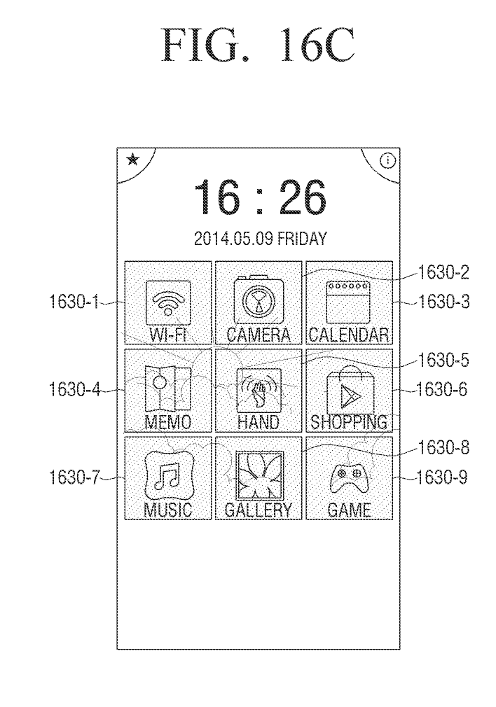

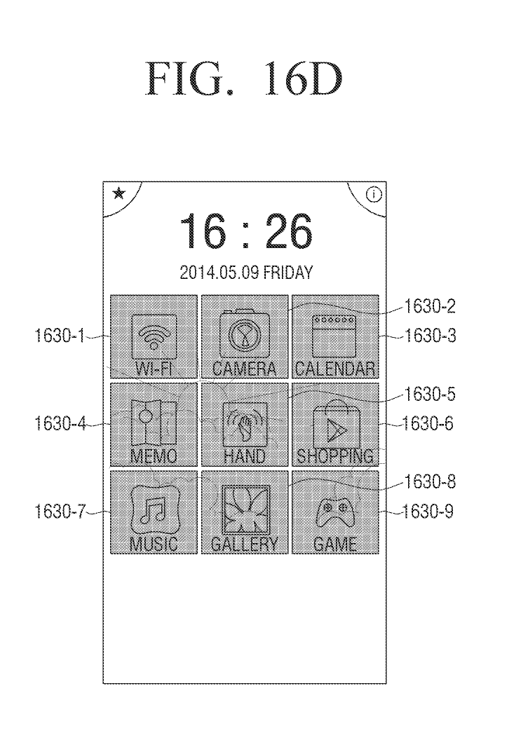

Specifically, referring to FIG. 16A, the controller 280 may provide a plurality of tile areas 1610-1 to 1610-9 having a background color for each of the first to the ninth icons.

In particular, the controller 280 may provide a list for assigning a background color and a transparency of the tile areas. For example, referring to FIG. 16B, the controller 280 may control the display 220 to display a setting list 1620 for various settings of a tile area where an icon is displayed.

In particular, as illustrated in FIG. 16B, if a user command to select a tile transparency in the setting list is input, the controller 280 may set the transparency of a tile area according to the selected tile transparency. For example, if the tile transparency is set to be high, as illustrated in FIG. 16C, the controller 280 may control the display 220 to display an icon in a plurality of tile areas 1630-1 to 1630-9 having a transparent background. On the other hand, if the tile transparency is set to be low, as illustrated in FIG. 16D, the controller 280 may control the display 220 to display an icon in a plurality of tile areas 1640-1 to 1640-9 having an opaque background.

In addition, the controller 280 may control the display 220 to change and display a color of a tile area where an icon is displayed.

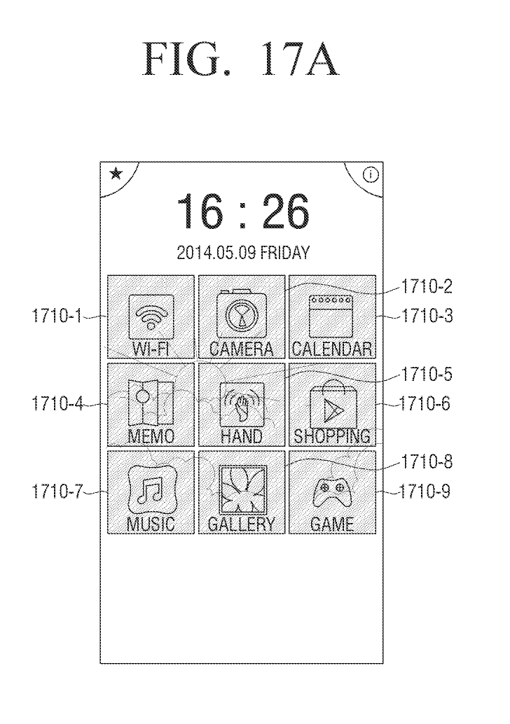

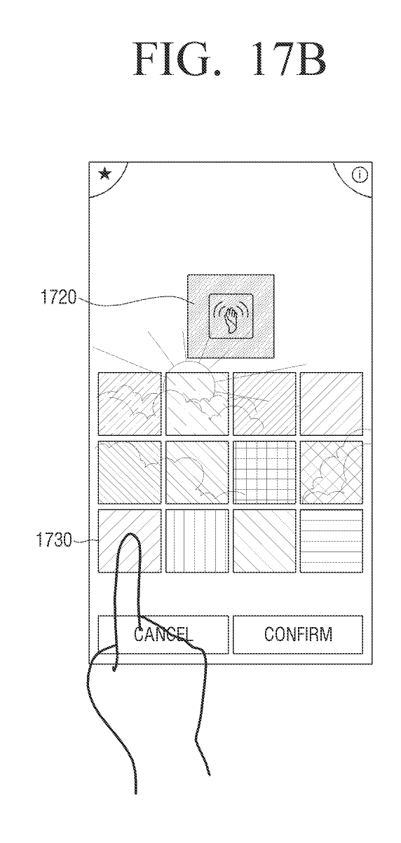

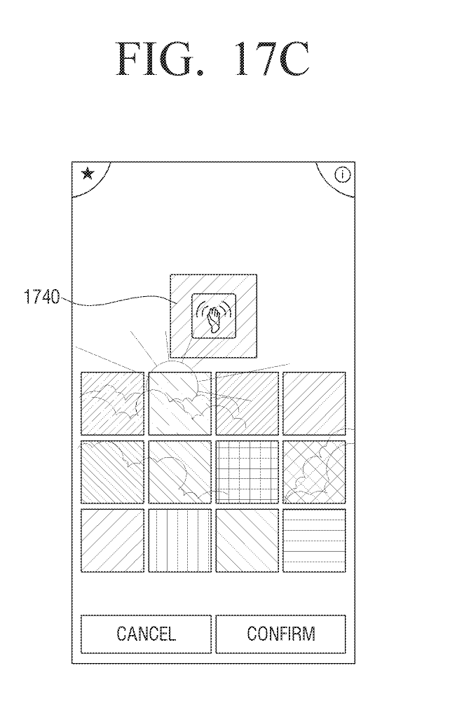

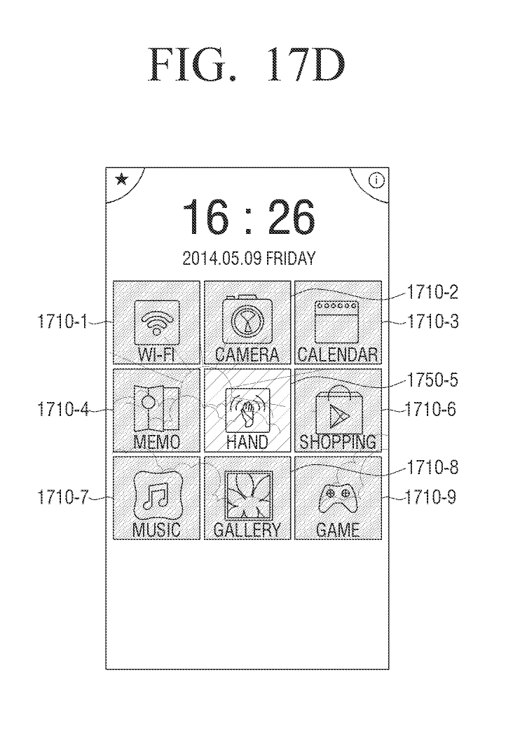

Specifically, referring to FIG. 17A, if a user command to select a fifth tile area 1710-5 where a fifth icon is displayed is input (for example, if a user command to press the fifth tile area 1710-5 for a predetermined time is input) while a plurality of tile areas 1710-1 to 1710-9 having a background color for each of a first to a ninth icon, the controller 280 may control the display 220 to display a tile color change UI 1730 as illustrated in FIG. 17B. In this case, the tile color change UI 1730 may include a preview area 1720. If another color is selected through the tile color change UI 1730, the controller 280 may control the display 220 to display the fifth tile area where the changed color in the preview area 1740 is applied as illustrated in FIG. 17C. If a tile color setting completion command is input, the controller 280 may control the display 220 to display the fifth tile area in a different color as illustrated in FIG. 17D.

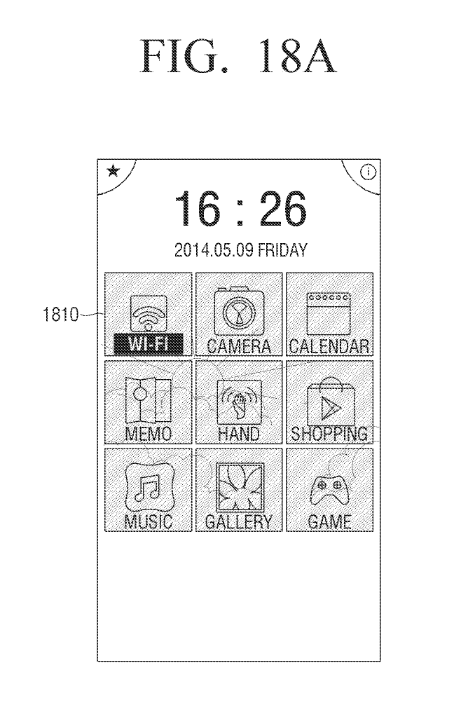

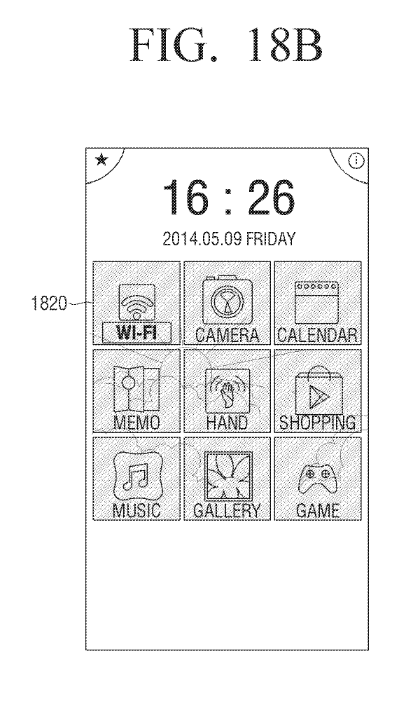

In addition, the controller 280 may set a method for displaying an icon name displayed in a tile area differently. Specifically, the controller 280 set a text of the first tile area 1810 such that the brightness and color of the text are in stark contrast to those of a background as illustrated in FIG. 18A. In addition, the controller 280 display another block area including a text of the first tile 1820 and perform a block processing with respect to the areas excluding a text in block areas including a text as illustrated in FIG. 18B.

As described above, by displaying an icon in a tile area with a background color, a user may have better visibility regarding icons and texts.

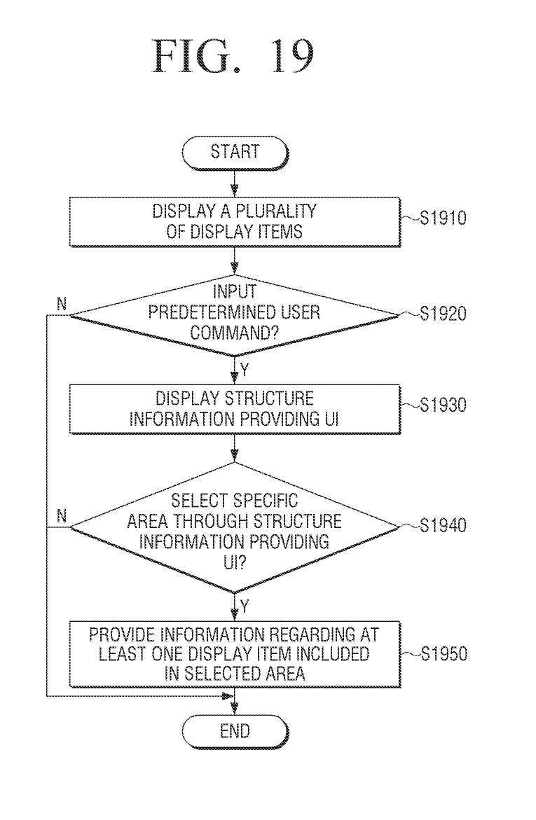

FIG. 19 is a flowchart provided to explain an information providing method of the user terminal device 100 according to an embodiment of the present disclosure.

First of all, the user terminal device 100 displays a plurality of display items at operation S1910. In this case, the display items may be a widget or an icon.

The user terminal device 100 determines whether a predetermined user command is input at operation S1920. In this case, the predetermined user command may be a user command to convert to a structure information providing mode.

If the predetermined user command is input at operation S1920-Y, the user terminal device 100 displays a structure information providing UI at operation S1930. In this case, the user terminal device 100 may display a structure information providing UI in a static form as illustrated in FIGS. 3A to 7 or a structure information providing UI in a dynamic form as illustrated in FIGS. 8A to 13B.

Subsequently, the user terminal device 100 determines whether a specific area is selected through a structure information providing UI at operation S1940.

If a specific area is selected through a structure information providing UI at operation S1940-Y, the user terminal device 100 provides structure information regarding at least one display item included in the selected area at operation S1950. In this case, the user terminal device 100 may provide structure information regarding a display item using at least one of visual, audio and tactile methods.

As described above, according to the various embodiments of the present disclosure, even if a user is in a situation where it is difficult to manipulate a user terminal device freely, the user may check structure information of a display item displayed on a display screen easily, and manipulate the display item based on the structure information smoothly.

Meanwhile, a method for providing information of a user terminal device according to the various embodiments of the present disclosure may be realized as a program and provided in the user terminal device or an input apparatus. In particular, the program including a method for controlling a user terminal device may be stored in a non-transitory computer readable medium and provided therein.

The non-transitory recordable medium refers to a medium which may store data semi-permanently rather than storing data for a short time such as a register, a cache, and a memory and may be readable by an apparatus. Specifically, the above-described various applications or programs may be stored in the non-transitory readable medium may be Compact Disc (CD), DVD, hard disk, Blu-ray disc, Universal Serial Bus (USB), memory card, ROM, etc. and provided therein.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing information of a user terminal device, the method comprising:
displaying a plurality of display items on a display screen;
displaying a User Interface (UI) for providing structure information in response to a predetermined user command being input; and
providing structure information regarding at least one display item included in the selected area in response to a specific area being selected through the structure information providing UI.

2. The method of claim 1, wherein the displaying of the UI for providing the structure information providing UI comprises:
displaying a structure information providing UI on an outer area of the display screen, wherein the providing the structure information includes, providing structure information regarding at least one display item included in a row corresponding to the touched point in response to a touch interaction of touching one point on an upper area or a lower area of the structure information providing UI displayed on the display screen being detected; and
providing structure information regarding at least one display item included in a column corresponding to the touched point in response to a touch interaction of touching one point on a right area or a left area of the structure information providing UI displayed on the display screen being detected.

3. The method of claim 2, further comprising:
selecting a display item group included in a row corresponding to a point where the first double tap interaction is detected in response to a first double tap interaction of tapping one point of an upper area or a lower area of the structure information providing UI displayed on the display screen in a row being detected; and
executing a display item included in a column corresponding to a point where the second double tap interaction is detected out of the display item group in response to a second double tap interaction of tapping one point of a right area or a left area of the structure information providing UI displayed on the display screen in a row being detected.

4. The method of claim 2, further comprising:
providing at least one of structure information regarding a plurality of display items included on the display screen, current time information, and incoming message information in response to a predetermined touch interaction regarding one point of a corner area of the structure information providing UI displayed on the display screen being detected.

5. The method of claim 2, further comprising:
providing a predetermined vibration feedback in response to a touch interaction of touching one point of the structure information providing UI displayed on an outer area of the display screen being detected.

6. The method of claim 2, further comprising:
providing structure information regarding at least one display item corresponding to a point where the touch interaction is detected in response to a predetermined touch interaction being detected on at least one of an upper area and a right area of the structure information providing UI displayed on the display screen; and
executing at least one display item corresponding to a point where the touch interaction is detected in response to a predetermined touch interaction being detected on at least one of a lower area and a left area of the structure information providing UI displayed on the display screen.

7. The method of claim 1,
wherein the displaying of the UI for providing the structure information providing UI comprises moving the structure information providing UI in a predetermined direction from one area of the display screen and displaying the structure information providing UI, and
wherein the providing of the structure information comprises providing structure information regarding the at least one display item in response to at least one display item existing on an area where the structure information providing UI is located while the structure information providing UI moves.

8. The method of claim 7,
wherein the structure information providing UI is in a form of bar, and
wherein the providing of the structure information comprises:
providing structure information regarding the at least one item included in a column where the structure information providing UI is located in response to at least one display item existing in a column where the structure information providing UI in a form of bar while the structure information providing in a form of bar movers in a lower direction from an upper area;
displaying a selection guide UI on one of the at least one display item in response to a column where the structure information providing UI is located being selected; and
executing the selected display item in response to the at least one display item being selected through the selection guide UI.

9. The method of claim 8, wherein the structure information providing UI in a form of bar adjusts at least one of a movement start location, a direction of movement, and a speed of movement according to a user interaction and a priority of a display item.

10. The method of claim 1, further comprising:
providing one of a vibration feedback and an audio feedback from a location where the changed display item is displayed in response to one of the plurality of display items being changed to another display item.

11. A user terminal device comprising:
a display configured to display a plurality of display items;
an input unit configured to receive a user command; and
a controller configured to:
control the display to display a structure information providing UI, in response to a predetermined user command being input through the input unit, control the display to display a structure information providing UI, and
provide structure information regarding at least one display item included in the selected area in response to a specific area being selected through the structure information providing UI.

12. The device of claim 11, wherein the controller is configured to:
control the display to display a structure information providing UI on an outer area of the display screen,
provide structure information regarding at least one display item included in a row corresponding to the touched point in response to a touch interaction of touching one point on an upper area or a lower area of the structure information providing UI displayed on the display screen being detected, and
provide structure information regarding at least one display item included in a column corresponding to the touched point in response to a touch interaction of touching one point on a right area or a left area of the structure information providing UI displayed on the display screen being detected.

13. The device of claim 12, wherein the controller is configured to:
select a display item group included in a row corresponding to a point where the first double tap interaction is detected in response to a first double tap interaction of tapping one point of an upper area or a lower area of the structure information providing UI displayed on the display screen in a row being detected, and
execute a display item included in a column corresponding to a point where the second double tap interaction is detected out of the display item group in response to a second double tap interaction of tapping one point of a right area or a left area of the structure information providing UI displayed on the display screen in a row being detected.

14. The device of claim 12, wherein the controller is configured to provide at least one of structure information regarding a plurality of display items included on the display screen, current time information, and incoming message information in response to a predetermined touch interaction regarding one point of a corner area of the structure information providing UI displayed on the display screen being detected.

15. The device of claim 12, further comprising:
a vibration unit configured to provide a vibration feedback, and
wherein the controller is configured to provide UI displayed on an outer area of the display screen being detected, provides a predetermined vibration feedback, in response to a touch interaction of touching one point of the structure information providing UI displayed on an outer area of the display screen being detected.

16. The device of claim 12, wherein the controller is configured to:
provide structure information regarding at least one display item corresponding a point where the touch interaction is detected in response to a predetermined touch interaction being detected on at least one of an upper area and a right area of the structure information providing UI displayed on the display screen, and
execute at least one display item corresponding to a point where the touch interaction is detected in response to a predetermined touch interaction being detected on at least one of a lower area and a left area of the structure information providing UI displayed on the display screen.

17. The device of claim 11,
wherein the displaying a structure information providing UI comprises moving the structure information providing UI in a predetermined direction from one area of the display screen and displaying the structure information providing UI, and
wherein the providing comprises, providing structure information regarding the at least one display item in response to at least one display item existing on an area where the structure information providing UI is located while the structure information providing UI moves.

18. The device of claim 17,
wherein the structure information providing UI is in a form of bar, and
wherein the controller is further configured to:
provide structure information regarding the at least one item included in a column where the structure information providing UI is located in response to at least one display item existing in a column where the structure information providing UI in a form of bar while the structure information providing in a form of bar movers in a lower direction from an upper area,
display a selection guide UI on one of the at least one display item in response to a column where the structure information providing UI is located being selected, and
execute the selected display item in response to the at least one display item being selected through the selection guide UI.

19. The device of claim 18, wherein the controller is configured to adjust at least one of a movement start location, a direction of movement, and a speed of movement according to a user interaction and a priority of a display item.

20. The device of claim 11, wherein the controller is configured to provide one of a vibration feedback and an audio feedback from a location where the changed display item is displayed in response to one of the plurality of display items being changed to another display item.
